(19) United States
(12) Patent Application Publication
(10) Pub. No.: US 2024/0144676 A1
(43) Pub. Date: May 2, 2024

(54) METHODS, SYSTEMS, ARTICLES OF MANUFACTURE AND APPARATUS FOR PROVIDING RESPONSES TO QUERIES REGARDING STORE OBSERVATION IMAGES

(71) Applicant: Nielsen Consumer LLC, Chicago, IL (US)

(72) Inventors: Roberto Arroyo, Madrid (ES); Sergio Álvarez Pardo, Meco (ES); Aitor Aller, Madrid (ES); Miguel Eduardo Ortiz, Chicago, IL (US); Luis Miguel Bergasa, Chicago, IL (US)

(21) Appl. No.: 17/976,528

(22) Filed: Oct. 28, 2022

(51) Int. Cl. G06V 20/00; G06F 40/40; G06V 10/82

(52) U.S. Cl. CPC G06V 20/36; G06F 40/40; G06V 10/82; G06V 2201/07; G06V 2201/10

(57) ABSTRACT

Methods, apparatus, systems and articles of manufacture are disclosed for providing responses to queries regarding store observation images. An example computer readable medium includes instructions that, when executed, cause a machine to at least obtain first metadata associated with a set of store dictionaries, select ones of the set of store dictionaries for use based on the associated first metadata, obtain second metadata associated with a set of question templates, select ones of the set of question templates for use based on the associated second metadata, generate question-answer pairs using the selected ones of the set of store dictionaries and the selected ones of the set of question templates, train a machine-learning model using the question-answer pairs, and provide query responses using the trained machine-learning model.

### FIELD OF THE DISCLOSURE

This disclosure relates generally to Visual Question Answering (VQA), and, more particularly, to methods, systems, articles of manufacture and apparatus for providing responses to queries regarding store observation images.

### BACKGROUND

Auditors visit retail locations to perform store observations and/or data collection used to identify strengths and weaknesses of store layouts, product placements, etc. These auditors often have recurring visual questions related to product information, store shelf layout, etc. that require answers on-site. Visual Question Answering (VQA) combines Computer Vision (CV), Natural Language Processing (NLP), and/or Knowledge Representation & Reasoning (KR&R) techniques to provide natural language responses to questions asked by users regarding images.

### BRIEF DESCRIPTION OF THE DRAWINGS

FIG. 1 is an illustration of an example electronic system including an example accelerator compiler to configure example acceleration circuitry based on an acceleration operation to be executed by the acceleration circuitry.

FIG. 2 is a block diagram of an example implementation of the accelerator compiler of FIG. 1.

FIG. 3 illustrates an example machine-learning (ML) and/or artificial intelligence (AI) model framework for receiving a query regarding a store observation image and outputting a response to the query.

FIG. 4 illustrates a word embedding architecture which may be utilized by the machine-learning (ML) and/or artificial intelligence (AI) model framework of FIG. 3 during training of the model.

FIG. 5 illustrates a generated set of question-answer templates, using which an ML/AI model may generate question-answer pairs.

FIG. 6 illustrates an example answer distribution over cropped images.

FIG. 7 illustrates an example answer distribution over whole images.

FIG. 8 illustrates an example model accuracy graph of the ML/AI model.

FIG. 9 illustrates an example model loss graph of the ML/AI model.

FIGS. 10-13 are flowcharts representative of machine readable instructions which may be executed to implement the example accelerator compiler of FIG. 2, in accordance with the teachings of this disclosure.

FIG. 14 is a block diagram of an example processing platform structured to execute the instructions of FIGS. 10-13 to implement the example accelerator compiler of FIG. 2.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform to distribute software (e.g., software corresponding to the example computer readable instructions of FIGS. 10-13) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy consumers).

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a Convolutional Neural Network (CNN) model is used. Using a CNN model enables weight sharing (e.g., reducing the number of weights that must be learned by the model), which reduces model training time and computation cost. In general, machine learning models/architectures that are suitable to use in the example approaches disclosed herein will be Neural Networks (NN), Deep Neural Networks (DNN), and/or Recurrent Neural Networks (RNN). However, other types of machine learning models could additionally or alternatively be used such as Support Vector Machines (SVM), Long Term Short Memory (LSTM), Gated Recurrent Units (GRU), etc.

In general, implementing an ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labeling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable amount of error has been reached. In examples disclosed herein, training may be performed at an electronic system (e.g., on one or more ML model(s)). Training is performed using hyperparameters that control how the learning is performed (e.g., a learning rate, a number of layers to be used in the machine learning model, etc.). In examples disclosed herein, hyperparameters that control a dictionary of values (e.g., for word embeddings) are used. Such hyperparameters are selected by, for example, manually and/or using statistical (random) sampling. In some examples, re-training may be performed. Such re-training may be performed in response to an accuracy metric not satisfying a threshold value.

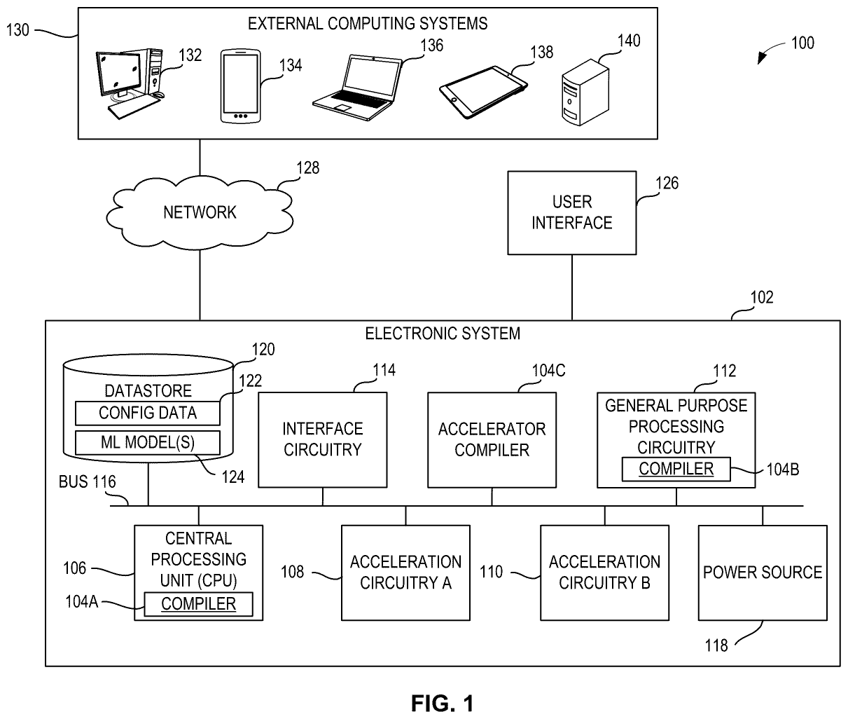

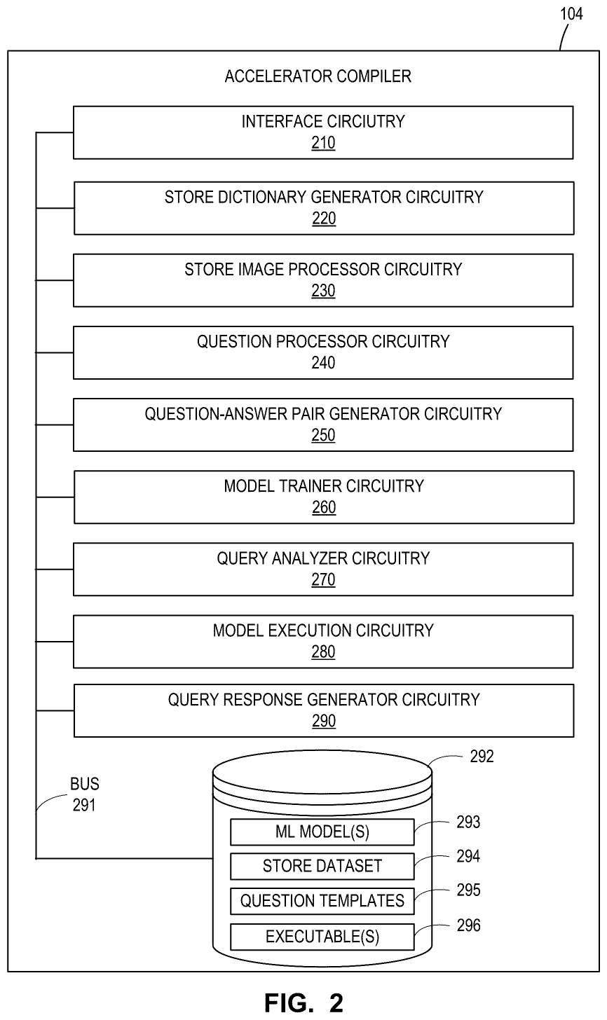

Training is performed using training data. In examples disclosed herein, the training data may originate from a datastore (e.g., an example datastore 292 explained further in conjunction with FIG. 2). Because supervised training is used, the training data is labeled. Labeling is applied to the training data by an accelerator compiler (e.g., an example accelerator compiler 104A-C explained further in conjunction with FIG. 1). In some examples, the training data is pre-processed using, for example, an interface (e.g., example interface circuitry 114 explained further in conjunction with FIG. 1). In some examples, the accelerator compiler 104A-C of FIG. 1 sub-divides the training data into a first portion of data for training the machine-learning model(s) 124, and a second portion of data for validating the example machine-learning (ML) model(s) 124 of FIG. 1.

Once training is complete, the model is deployed for use as an executable construct that processes an input and provides an output based on the network of nodes and connections defined in the model. The model is stored at a datastore. The model may then be executed by example model execution circuitry 280 (explained further in conjunction with FIG. 2). In some examples, the platform on which the model is executed may have particular operand precision and/or accuracy constraints.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Large numbers of field and/or store auditors frequently (e.g., daily) visit retail locations to collect data (e.g., product data, sales data, etc.) and/or perform analysis on product placement, store layout, etc. to improve store performance (e.g., by improving sales performance of products of interest in a given store). These store auditors often have recurrent doubts regarding specific products observed on store shelves, with a frequency of these doubts exacerbated by cultural gaps and/or regional differences in specific products and/or brands. For example, a field auditor and/or store auditor may visit a store in a region different from one they are used to. Subsequently, as a result of regional differences, languages barriers, etc., the field auditor may, for example, not recognize a particular product or set of similar products on a store shelf, thus halting and/or otherwise delaying the field auditor's ability to continue collecting data relating to that particular shelf, surrounding shelves, etc. Therefore, efficient provision of answers (e.g., determination of answers) to field auditors' questions regarding particular observations on store shelves (e.g., “what type of products are in this image?”, “are there bananas on this shelf?”, “are there any wine bottles present?”, “what does this product do?”, etc.) promote reduction in waste of resources and/or time. A higher accuracy of answers is also desired because a field auditor's understanding of store shelves and/or products directly influences their data collection and/or analysis processes. Therefore, a mistaken belief in a particular store observation has undesirable implications in accuracy of overall store analysis, product category analysis, etc. Stated differently, a reliance on current techniques that consider human discretion cause wasted time and/or erroneous distribution instructions (e.g., excess product is delivered to a particular store because of auditor undercount errors, insufficient product is delivered to a particular store because of auditor overcount errors, etc.).

Current approaches to providing answers to questions regarding store observations involve human operators (e.g., working at a helpdesk, call center, etc.) who review an input image and/or question and output an answer to the query. These approaches introduce a high latency between asking of a question and receipt of an answer to the question, since a human must individually review each question and provide an answer. In a fast-paced audit and/or data collection situation, this massively decreases an efficiency of the field auditors and, thus, wastes resources and/or time. Additionally, involvement of human discretion in answering these store observation questions further involves a high measure of inaccuracy in the provided answers, due to mistakes caused by guesswork, blurry images, worker fatigue, language barriers, regional differences, etc.

Additional approaches to providing answers to questions regarding store observations use Visual Question Answering (VQA) techniques that involve a limited dataset and a resulting inability to accurately generalize answers over a wide range of products and/or retail locations. These approaches similarly introduce a high measure of inaccuracy, as a limited dataset results in inaccurate answers to questions regarding store observations and/or observation images. Furthermore, the extensive software retraining and/or testing employed and/or required by these approaches (e.g., due to a high loss metric not satisfying a threshold value) often produces unsatisfactory, delayed, and/or unclear recommendations (e.g., particularly during the inference phase of the ML/AI model). Furthermore, the frequent repetition of testing and/or training of an ML/AI model with a limited dataset required to ensure optimum model results (e.g., results that are consistent with ground-truth data testing) is resource-intensive, computationally-expensive, and/or challenging, particularly in instances where test datasets and/or training datasets are large in volume and/or are frequently-evolving. That is, the software testing required to ensure model results fall within an acceptable range of accuracy and/or loss may cause validation cycles to become prolonged. Additionally, the current approaches described herein may only be applicable in a limited number of situations due to a foreseeable and/or observed risk of an incorrect cutoff decision being made, particularly when the triage performed by a model employing a limited dataset produces an incorrect confidence score. In short, the current approaches frequently over-complicate the process of deploying ML/AI models by complicating the training phase and/or the post-training testing/inference phase.

Example methods for efficiently providing accurate answers to questions regarding store observations focus on a broadening of a dictionary and/or dataset involved in training of ML/AI model(s), as well as generation of question-answer pairs to promote wider generalizability. Such examples reduce the amount of misinformation spread through inaccurate answers provided using human discretion and/or ML/AI models trained using a limited dataset, and additionally reduces computational expense and/or resources. That is, in example methods disclosed herein, an accurate and/or widely generalizable dataset is synthetically generated (e.g., through dictionary updating, generation of question-answer pairs, etc.), using machine-learning (ML) and/or artificial intelligence (AI) techniques to train a more adaptable ML/AI model or a set of ML/AI models.

FIG. 1 is an illustration of an example computing environment 100 including an example electronic system 102, which includes an example accelerator compiler 104A-C to configure an ML/AI accelerator to execute high-accuracy question answering operations as improved visual question answering (VQA) operations, etc. to achieve improved accelerator efficiency and performance. In examples disclosed herein, the accelerator compiler 104A-C is shown in different example implementations, such as within a Central Processing Unit (CPU), within a Graphics Processing Unit (GPU), as a standalone component, etc., however, any other example implementation not limited hereinto may be utilized. In some examples, the accelerator compiler 104A-C obtains an output from a machine-learning framework (e.g., a NN framework) and compiles the output for implementation on the accelerator based on the scaling operation to be executed and/or otherwise performed by the accelerator.

The electronic system 102 of the illustrated example of FIG. 1 includes an example central processing unit (CPU) 106, first example acceleration circuitry (ACCELERATION CIRCUITRY A) 108, second example acceleration circuitry (ACCELERATION CIRCUITRY B) 110, example general purpose processing circuitry 112, example interface circuitry 114, an example bus 116, an example power source 118, and an example datastore 120. In this example, the datastore 120 includes example configuration data (CONFIG DATA) 122 and example machine-learning model(s) (ML MODEL(S)) 124. Further depicted in the illustrated example of FIG. 1 are an example user interface 126, an example network 128, and example external electronic systems 130.

In some examples, the electronic system 102 is a system on a chip (SoC) representative of one or more integrated circuits (ICs) (e.g., compact ICs) that incorporate components of a computer or other electronic system in a compact format. For example, the electronic system 102 may be implemented with a combination of one or more programmable processors, hardware logic, and/or hardware peripherals and/or interfaces. Additionally or alternatively, the example electronic system 102 of FIG. 1 may include memory, input/output (I/O) port(s), and/or secondary storage. For example, the electronic system 102 includes the acceleration compiler 104A-C, the CPU 106, the first acceleration circuitry 108, the second acceleration circuitry 110, the general purpose processing circuitry 112, the interface circuitry 114, the bus 116, the power source 118, the datastore 120, the memory, the I/O port(s), and/or the secondary storage all on the same substrate (e.g., silicon substrate, semiconductor-based substrate, etc.). In some examples, the electronic system 102 includes digital, analog, mixed-signal, radio frequency (RF), or other signal processing functions.

In the illustrated example of FIG. 1, the first acceleration circuitry 108 is an artificial intelligence (AI) accelerator. For example, the first acceleration circuitry 108 may be implemented by a hardware accelerator configured to accelerate AI tasks or workloads, such as NNs (e.g., artificial neural networks (ANNs)), machine vision, machine learning, etc. In some examples, the first acceleration circuitry 108 may implement an ML/AI accelerator (e.g., a sparse hardware accelerator). In some examples, the first acceleration circuitry 108 may implement a vision processing unit (VPU) to effectuate machine or computer vision computing tasks, train and/or execute a physical neural network, and/or train and/or execute a neural network. In some examples, the first acceleration circuitry 108 may train and/or execute a convolution neural network (CNN), a deep neural network (DNN), an ANN, a recurrent neural network (RNN), etc., and/or a combination thereof.

In the illustrated example of FIG. 1, the second acceleration circuitry 110 is a graphics processing unit (GPU). For example, the second acceleration circuitry 110 may be a GPU that generates computer graphics, executes general-purpose computing, etc. In some examples, the second acceleration circuitry 110 is another instance of the first acceleration circuitry 108. In some such examples, the electronic system 102 may provide portion(s) of AI/ML workloads to be executed in parallel by the first acceleration circuitry 108 and the second acceleration circuitry 110.

The general purpose processing circuitry 112 of the example of FIG. 1 is a programmable processor, such as a CPU or a GPU. Alternatively, one or more of the first acceleration circuitry 108, the second acceleration circuitry 110, and/or the general purpose processing circuitry 112 may be a different type of hardware such as a digital signal processor (DSP), an application specific integrated circuit (ASIC), a programmable logic device (PLD), and/or a field programmable logic device (FPLD) (e.g., a field-programmable gate array (FPGA)).

In the illustrated example of FIG. 1, the interface circuitry 114 is hardware that may implement one or more interfaces (e.g., computing interfaces, network interfaces, etc.). For example, the interface circuitry 114 may be hardware, software, and/or firmware that implements a communication device (e.g., a network interface card (NIC), a smart NIC, a gateway, a switch, etc.) such as a transmitter, a receiver, a transceiver, a modem, a residential gateway, a wireless access point, and/or a network interface to facilitate exchange of data with external machines (e.g., computing devices of any kind) via the network 128. In some examples, the communication is effectuated via a Bluetooth® connection, an Ethernet connection, a digital subscriber line (DSL) connection, a wireless fidelity (Wi-Fi) connection, a telephone line connection, a coaxial cable system, a satellite system, a line-of-site wireless system, a cellular telephone system, an optical connection (e.g., a fiber-optic connection), etc. For example, the interface circuitry 114 may be implemented by any type of interface standard, such as a Bluetooth® interface, an Ethernet interface, a Wi-Fi interface, a universal serial bus (USB), a near field communication (NFC) interface, and/or a peripheral component interconnect express (PCIe) interface.

The electronic system 102 includes the power source 118 to deliver power to hardware of the electronic system 102. In some examples, the power source 118 may implement a power delivery network. For example, the power source 118 may implement an alternating current-to-direct current (AC/DC) power supply. In some examples, the power source 118 may be coupled to a power grid infrastructure such as an AC main (e.g., a 110 volt (V) AC grid main, a 220V AC grid main, etc.). Additionally, or alternatively, the power source 118 may be implemented by a battery. For example, the power source 118 may be a limited energy device, such as a lithium-ion battery or any other chargeable battery or power source. In some such examples, the power source 118 may be chargeable using a power adapter or converter (e.g., an AC/DC power converter), a wall outlet (e.g., a 110 V AC wall outlet, a 220 V AC wall outlet, etc.), a portable energy storage device (e.g., a portable power bank, a portable power cell, etc.), etc.

The electronic system 102 of the illustrated example of FIG. 1 includes the datastore 120 to record data (e.g., the configuration data 122, the ML model(s) 124, etc.). The datastore 120 of this example may be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The datastore 120 may additionally or alternatively be implemented by one or more double data rate (DDR) memories, such as DDR, DDR2, DDR3, DDR4, mobile DDR (mDDR), etc. The datastore 120 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example, the datastore 120 is illustrated as a single datastore, the datastore 120 may be implemented by any number and/or type(s) of datastores. Furthermore, the data stored in the datastore 120 may be in any data format such as, for example, binary data, comma delimited data, tab delimited data, structured query language (SQL) structures, an executable, etc.

In the illustrated example of FIG. 1, the electronic system 102 is in communication with the user interface 126. For example, the user interface 126 may be implemented by a graphical user interface (GUI), an application user interface, etc., which may be presented to a user on a display device in circuit with and/or otherwise in communication with the electronic system 102. In some such examples, a user (e.g., a developer, an IT administrator, a customer, etc.) controls the electronic system 102, configures, trains, and/or executes the ML model(s) 124, etc., via the user interface 126. Alternatively, the electronic system 102 may include and/or otherwise implement the user interface 126.

In the illustrated example of FIG. 1, the accelerator compiler 104A-C, the CPU 106, the first acceleration circuitry 108, the second acceleration circuitry 110, the general purpose processing circuitry 112, the interface circuitry 114, the power source 118, and the datastore 120 are in communication with one(s) of each other via the bus 116. For example, the bus 116 may be implemented by at least one of an Inter-Integrated Circuit (I2C) bus, a Serial Peripheral Interface (SPI) bus, a Peripheral Component Interconnect (PCI) bus, or a PCIe bus. Additionally, or alternatively, the bus 116 may be implemented by any other type of computing or electrical bus.

In the illustrated example of FIG. 1, the network 128 is the Internet. However, the network 128 of this example may be implemented using any suitable wired and/or wireless network(s) including, for example, one or more data buses, one or more Local Area Networks (LANs), one or more wireless LANs, one or more cellular networks, one or more private networks, one or more public networks, etc. In some examples, the network 128 enables the electronic system 102 to be in communication with one(s) of the external electronic systems 130.

In the illustrated example of FIG. 1, the external electronic systems 130 include and/or otherwise implement one or more electronic (e.g., computing) devices on which the ML model(s) 124 is/are to be executed. In this example, the external electronic systems 130 include an example desktop computer 132, an example mobile device (e.g., a smartphone, an Internet-enabled smartphone, etc.) 134, an example laptop computer 136, an example tablet (e.g., a tablet computer, an Internet-enabled tablet computer, etc.) 138, and an example server 140. In some examples, fewer or more than the external electronic systems 130 depicted in FIG. 1 may be used. Additionally, or alternatively, the external electronic systems 130 may include, correspond to, and/or otherwise be representative of, any other type and/or quantity of computing devices.

In some examples, one or more of the external electronic systems 130 execute one(s) of the ML model(s) 124 to process a computing workload (e.g., an AI/ML workload). For example, the mobile device 134 can be implemented as a cell or mobile phone having one or more processors (e.g., a CPU, a GPU, a VPU, an AI or NN specific processor, etc.) on a single SoC to process an AI/ML workload using one(s) of the ML model(s) 124. In some examples, the desktop computer 132, the laptop computer 136, the tablet computer, and/or the server 140 may be implemented as electronic (e.g., computing) device(s) having one or more processors (e.g., a CPU, a GPU, a VPU, an AI/NN specific processor, etc.) on one or more SoCs to process AI/ML workload(s) using one(s) of the ML model(s) 124. In some examples, the server 140 may implement one or more servers (e.g., physical servers, virtualized servers, etc., and/or a combination thereof) that may implement a data facility, a cloud service (e.g., a public or private cloud provider, a cloud-based repository, etc.), etc., to process AI/ML workload(s) using one(s) of the ML model(s) 124.

In the illustrated example of FIG. 1, the electronic system 102 includes a first accelerator compiler 104A (e.g., a first instance of the accelerator compiler 104A-C), a second accelerator compiler 104B (e.g., a second instance of the accelerator compiler 104A-C), and a third accelerator compiler 104C (e.g., a third instance of the accelerator compiler 104A-C) (collectively referred to herein as the accelerator compiler 104A-C unless specified otherwise). In this example, the first accelerator compiler 104A is implemented by the CPU 106 (e.g., implemented by hardware, software, and/or firmware of the CPU 106).

In the illustrated example of FIG. 1, the second accelerator compiler 104B is implemented by the general purpose processing circuitry 112 (e.g., implemented by hardware, software, and/or firmware of the general purpose processing circuitry 112). In this example, the third accelerator compiler 104C is external to the CPU 106. For example, the third accelerator compiler 104C may be implemented by hardware, software, and/or firmware of the electronic system 102. In some such examples, the third accelerator compiler 104C may be implemented by one or more analog or digital circuit(s), logic circuits, programmable processor(s), programmable controller(s), GPU(s), DSP(s), ASIC(s), PLD(s), and/or FPLD(s)).

In some examples, one or more of the first accelerator compiler 104A, the second accelerator compiler 104B, the third accelerator compiler 104C, and/or portion(s) thereof, may be virtualized, such as by being implemented with one or more containers, one or more virtual resources (e.g., virtualizations of compute, memory, networking, storage, etc., physical hardware resources), one or more virtual machines, etc. In some examples, one or more of the first accelerator compiler 104A, the second accelerator compiler 104B, the third accelerator compiler 104C, and/or portion(s) thereof, may be implemented by different resource(s) of the electronic system 102. Alternatively, the electronic system 102 may not include one or more of the first accelerator compiler 104A, the second accelerator compiler 104B, and/or the third accelerator compiler 104C.

In the illustrated example of FIG. 1, the accelerator compiler 104A-C may compile an AI/ML framework based on the configuration data 122 for implementation on one(s) of the acceleration circuitry 108, 110. In some examples, the configuration data 122 may include AI/ML configuration data (e.g., register configurations, activation data, activation sparsity data, weight data, weight sparsity data, hyperparameters, etc.), a convolution operation to be executed (e.g., a 2-D convolution, a depthwise convolution, a grouped convolution, a dilated convolution, etc.), a non-convolution operation (e.g., an elementwise addition operation), etc., and/or a combination thereof. In some examples, the accelerator compiler 104A-C may compile the AI/ML framework to generate an executable construct that may be executed by the one(s) of the acceleration circuitry 108, 110.

In the illustrated example of FIG. 1, the accelerator compiler 104A-C may instruct, direct, and/or otherwise invoke one(s) of the acceleration circuitry 108, 110 to execute one(s) of the ML model(s) 124. For example, the ML model(s) 124 may implement AI/ML models. AI, including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the machine-learning model(s) 124 may be trained with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the accelerator compiler 104A-C generates the machine-learning model(s) 124 as neural network model(s). The accelerator compiler 104A-C may invoke the interface circuitry 114 to transmit the machine-learning model(s) 124 to one(s) of the external electronic systems 130. Using a neural network model enables the acceleration circuitry 108, 110 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine (SVM) or network, Naive Bayes, etc. In some examples, the accelerator compiler 104A-C may compile and/or otherwise generate one(s) of the machine-learning model(s) 124 as lightweight machine-learning models.

In general, implementing an ML/AI system involves two phases, a learning/training phase and an inference phase. In the learning/training phase, a training algorithm is used to train the machine-learning model(s) 124 to operate in accordance with patterns and/or associations based on, for example, training data. In general, the machine-learning model(s) 124 include(s) internal parameters (e.g., the configuration data 122) that guide how input data is transformed into output data, such as through a series of nodes and connections within the machine-learning model(s) 124 to transform input data into output data. Additionally, hyperparameters (e.g., the configuration data 122) are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the accelerator compiler 104A-C may invoke supervised training to use inputs and corresponding expected (e.g., labeled) outputs to select parameters (e.g., by iterating over combinations of select parameters) for the machine-learning model(s) 124 that reduce model error. As used herein, “labeling” refers to an expected output of the machine learning model (e.g., a classification, an expected output value, etc.). Alternatively, the accelerator compiler 104A-C may invoke unsupervised training (e.g., used in deep learning, a subset of machine learning, etc.) that involves inferring patterns from inputs to select parameters for the machine-learning model(s) 124 (e.g., without the benefit of expected (e.g., labeled) outputs).

In some examples, the accelerator compiler 104A-C trains the machine-learning model(s) 124 using unsupervised clustering of operating observables. However, the accelerator compiler 104A-C may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the accelerator compiler 104A-C may train the machine-learning model(s) 124 until the level of error is no longer reducing. In some examples, the accelerator compiler 104A-C may train the machine-learning model(s) 124 locally on the electronic system 102 and/or remotely at an external electronic system (e.g., one(s) of the external electronic systems 130) communicatively coupled to the electronic system 102. In some examples, the accelerator compiler 104A-C trains the machine-learning model(s) 124 using hyperparameters that control how the learning is performed (e.g., a learning rate, a number of layers to be used in the machine learning model, etc.). In some examples, the accelerator compiler 104A-C may use hyperparameters that control model performance and training speed such as the learning rate and regularization parameter(s). The accelerator compiler 104A-C may select such hyperparameters by, for example, trial and error to reach an optimal model performance. In some examples, the accelerator compiler 104A-C utilizes Bayesian hyperparameter optimization to determine an optimal and/or otherwise improved or more efficient network architecture to avoid model overfitting and improve the overall applicability of the machine-learning model(s) 124. Alternatively, the accelerator compiler 104A-C may use any other type of optimization. In some examples, the accelerator compiler 104A-C may perform re-training. The accelerator compiler 104A-C may execute such re-training in response to override(s) by a user of the electronic system 102, a receipt of new training data, etc.

In some examples, the accelerator compiler 104A-C facilitates the training of the machine-learning model(s) 124 using training data. In some examples, the accelerator compiler 104A-C utilizes training data that originates from locally generated data. In some examples, the accelerator compiler 104A-C utilizes training data that originates from externally generated data. In some examples where supervised training is used, the accelerator compiler 104A-C may label the training data. Labeling is applied to the training data by a user manually or by an automated data pre-processing system. In some examples, the accelerator compiler 104A-C may pre-process the training data using, for example, an interface (e.g., the interface circuitry 114). In some examples, the accelerator compiler 104A-C sub-divides the training data into a first portion of data for training the machine-learning model(s) 124, and a second portion of data for validating the machine-learning model(s) 124.

Once training is complete, the accelerator compiler 104A-C may deploy the machine-learning model(s) 124 for use as an executable construct that processes an input and provides an output based on the network of nodes and connections defined in the machine-learning model(s) 124. The accelerator compiler 104A-C may store the machine-learning model(s) 124 in the datastore 120. In some examples, the accelerator compiler 104A-C may invoke the interface circuitry 114 to transmit the machine-learning model(s) 124 to one(s) of the external electronic systems 130. In some such examples, in response to transmitting the machine-learning model(s) 124 to the one(s) of the external electronic systems 130, the one(s) of the external electronic systems 130 may execute the machine-learning model(s) 124 to execute AI/ML workloads with at least one of improved efficiency or performance.

Once trained, the deployed one(s) of the machine-learning model(s) 124 may be operated in an inference phase to process data. In the inference phase, data to be analyzed (e.g., live data) is input to the machine-learning model(s) 124, and the machine-learning model(s) 124 execute(s) to create an output. This inference phase can be thought of as the AI “thinking” to generate the output based on what it learned from the training (e.g., by executing the machine-learning model(s) 124 to apply the learned patterns and/or associations to the live data). In some examples, input data undergoes pre-processing before being used as an input to the machine-learning model(s) 124. Moreover, in some examples, the output data may undergo post-processing after it is generated by the machine-learning model(s) 124 to transform the output into a useful result (e.g., a display of data, a detection and/or identification of an object, an instruction to be executed by a machine, etc.).

In some examples, output of the deployed one(s) of the machine-learning model(s) 124 may be captured and provided as feedback. By analyzing the feedback, an accuracy of the deployed one(s) of the machine-learning model(s) 124 can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the accelerator compiler 104A-C configures one(s) of the acceleration circuitry 108, 110 to execute a convolution operation, such as 2-D convolution operation. For example, the acceleration circuitry 108, 110 may implement a CNN. In some examples, CNNs ingest and/or otherwise process images as tensors, which are matrices of numbers with additional dimensions. For example, a CNN can obtain an input image represented by 3-D tensors, where a first and a second dimension correspond to a width and a height of a matrix and a third dimension corresponds to a depth of the matrix. For example, the width and the height of the matrix can correspond to a width and a height of an input image and the depth of the matrix can correspond to a color depth (e.g., a color layer) or a color encoding of the image (e.g., a Red-Green-Blue (RGB) encoding).

A typical CNN may also receive an input and transform the input through a series of hidden layers. For example, a CNN may have a plurality of convolution layers, pooling layers, and/or fully-connected layers. In some such examples, a CNN may have a plurality of layer triplets including a convolution layer, a pooling layer, and a fully-connected layer. In some examples, a CNN may have a plurality of convolution and pooling layer pairs that output to one or more fully-connected layers. In some examples, a CNN may include 20 layers, 30 layers, etc.

In some examples, the acceleration circuitry 108, 110 may execute a convolution layer to apply a convolution function or operation to map images of an input (previous) layer to the next layer in a CNN. In some examples, the convolution may be three-dimensional (3-D) because each input layer can have multiple input features (e.g., input channels) associated with an input image. The acceleration circuitry 108, 110 may execute the convolution layer to perform convolution by forming a regional filter window in each individual input channel and generating output data or activations by calculating a product of (1) a filter weight associated with the regional filter window and (2) the input data covered by the regional filter window. For example, the acceleration circuitry 108, 110 may determine an output feature of an input image by using the convolution filter to scan a plurality of input channels including a plurality of the regional filter windows.

In some examples, the acceleration circuitry 108, 110 may execute a pooling layer to extract information from a set of activations in each output channel. The pooling layer may perform a maximum pooling operation corresponding to a maximum pooling layer or an average pooling operation corresponding to an average pooling layer. In some examples, the maximum pooling operation may include selecting a maximum value of activations within a pooling window. In some examples, the average pooling operation may include calculating an average value of the activations within the pooling window.

In some examples, the acceleration circuitry 108, 110 may execute a fully-connected layer to obtain the data calculated by the convolution layer(s) and/or the pooling layer(s) and/or classify the data into one or more classes. In some examples, the fully-connected layer may determine whether the classified data corresponds to a particular image feature of the input image. For example, the acceleration circuitry 108, 110 may execute the fully-connected layer to determine whether the classified data corresponds to a simple image feature (e.g., a horizontal line) or a more complex image feature like an animal (e.g., a cat).

In some examples, the accelerator compiler 104A-C may configure one(s) of the acceleration circuitry 108, 110 to execute non-2-D convolution operations as 2-D convolution operations. For example, the accelerator compiler 104A-C may configure the one(s) of the acceleration circuitry 108, 110 to implement a depthwise convolution operation, an elementwise addition operation, a grouped convolution operation, a dilated convolution operation, a custom operation (e.g., a custom convolution, a custom acceleration operation, etc.), etc., as a 2-D convolution operation. In some such examples, the accelerator compiler 104A-C may instruct the one(s) of the acceleration circuitry 108, 110 to internally generate data rather than receive the data from the accelerator compiler 104A-C, the configuration data 122, etc. For example, the accelerator compiler 104A-C may instruct the first acceleration resource to generate at least one of activation sparsity data, weight sparsity data, or weight data based on the acceleration operation to be executed by the first acceleration circuitry 108. In some such examples, the accelerator compiler 104A-C may instruct the one(s) of the acceleration circuitry 108, 110 to execute the one(s) of the ML model(s) 124 based on the data generated by the one(s) of the acceleration circuitry 108, 110, which may be based on a convolution operation to be executed by the one(s) of the acceleration circuitry 108, 110.

FIG. 2 is a block diagram of an example accelerator compiler 104. In some examples, the accelerator compiler 104 of FIGS. 1 and/or 2 may implement one or more of the accelerator compiler 104A-C of FIG. 1 to perform generation of question-answer pairs to increase efficiency of query response provision and/or improve a response accuracy, while decreasing resource and/or time expenditure. The accelerator compiler 104A-C of FIG. 2 may be instantiated (e.g., creating an instance of, bring into being for any length of time, materialize, implement, etc.) by processor circuitry such as a central processing unit executing instructions. Additionally, or alternatively, the accelerator compiler 104A-C of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the illustrated example of FIG. 2, the accelerator compiler 104 may configure a hardware accelerator, such as example interface circuitry 210, example store dictionary generator circuitry 220, example store image processor circuitry 230, example question processor circuitry 240, example question-answer pair generator circuitry 250, example model trainer circuitry, example query analyzer circuitry 260, example query analyzer circuitry 270, example model execution circuitry 280, and/or example query response generator circuitry 290, further including an example bus 291, an example datastore 292 containing example machine-learning (ML) model(s) 293, an example store dataset 294, example question templates 295, and example executable(s) 296.

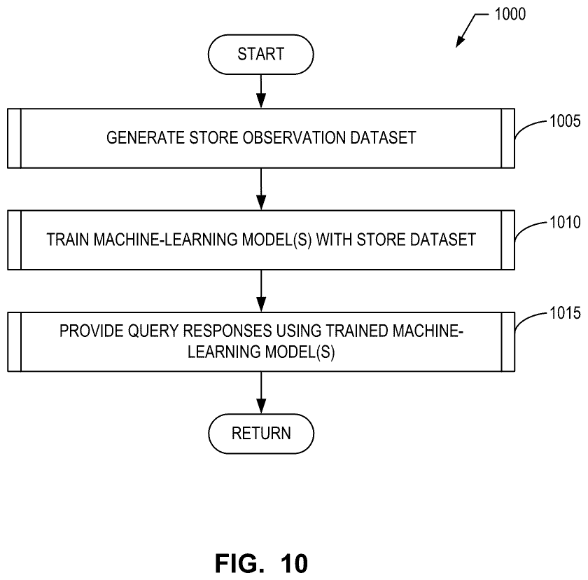

In operation, the example interface circuitry 210 obtains (e.g., retrieves, receives, acquires) any number of template questions and/or associated images (e.g., regarding store observations) to execute a machine-learning (ML) operation (e.g., a Visual Question Answering (VQA) operation). In examples disclosed herein, template questions represent a number of questions that are relevant to and/or otherwise associated with a retail environment of interest. In some examples, a first set of template questions are in the English language, associated with a grocery store environment, and in the United Kingdom (UK). As such, when an auditor is actively performing auditing tasks in one or more retail establishments in the UK, corresponding relevant questions will serve as informational triggers for data gathering (e.g., “Are there crisps on the shelf?”, “Are product prices shown in Pounds Sterling?”, etc.). In some examples, a second set of template questions are in the Spanish language, associated with a retail manufacturing environment in Spain. As such, when an auditor is performing auditing tasks in one or more retail manufacturing environments in Spain, the first set of template questions would not apply, as the language and/or relevant set of questions have changed. Therefore, by allowing a specific range of template questions (e.g., along with a particular associated dictionary), regional differences, language variation, industry changes, etc. are accounted for. Additionally, in examples disclosed herein, a field auditor's question typically accompanies a store observation image (e.g., that they may have captured on their personal computing device, etc.). For example, a field auditor may present an image of a store shelf and as “Are there bananas here?”. In examples disclosed herein, the interface circuitry 210 may obtain the template questions from the example datastore 120, the example external computing systems 130 of FIG. 1, etc. In examples disclosed herein, this source may be any type of database, Internet source, etc. Additionally, in examples disclosed herein, the interface circuitry 210 may receive and/or transmit data to a network or other parts of the electronic system 102 of FIG. 1, such as the acceleration circuitry 108, 110 of FIG. 1. In some examples, the interface circuitry 210 may also be the interface and/or cable from a laptop to a GPU and/or FPGA to configure an operation such as a loading of an image. In some examples, the example interface circuitry 210 is instantiated by processor circuitry executing interface circuitry 210 instructions and/or configured to perform operations such as those represented by the flowcharts of FIGS. 10-13.

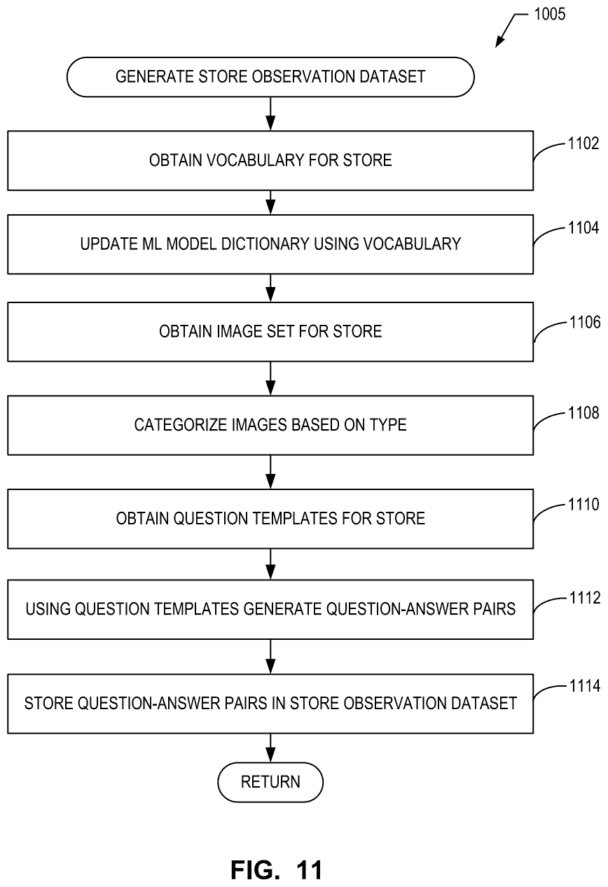

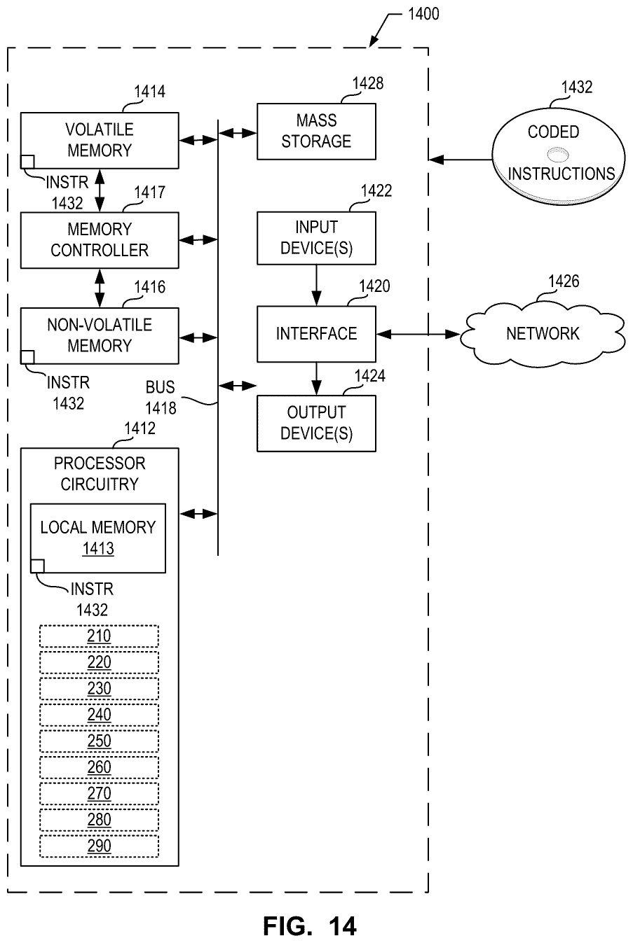

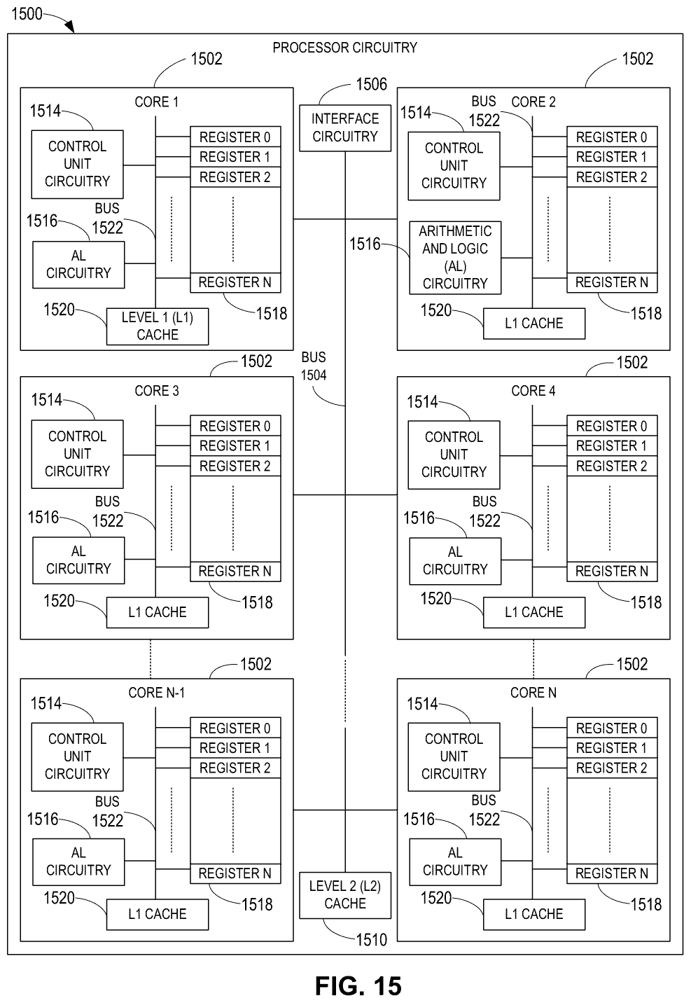

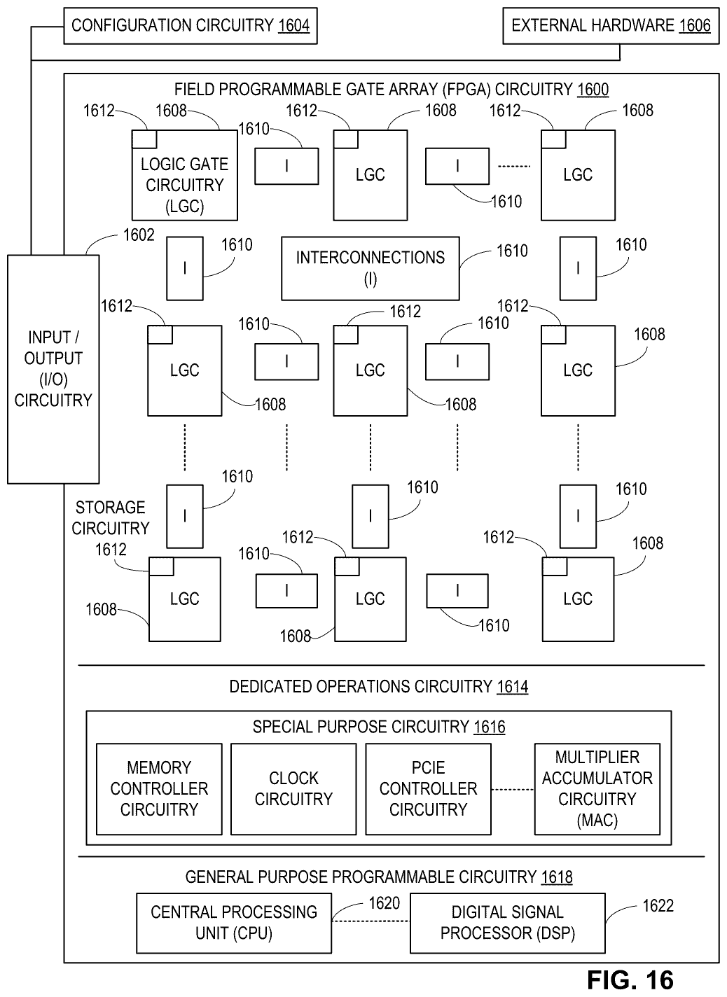

In some examples, the interface circuitry 210 includes means for obtaining any input (e.g., the store dataset 294) to execute a machine-learning (ML) operation (e.g., a Visual Question Answering (VQA) operation). For example, the means for obtaining any input (e.g., the store dataset 294) to execute a machine-learning (ML) operation (e.g., a Visual Question Answering (VQA) operation) may be implemented by interface circuitry 210. In some examples, the interface circuitry 210 may be instantiated by processor circuitry such as the example processor circuitry 1412 of FIG. 14. For instance, the interface circuitry 210 may be instantiated by the example microprocessor 1500 of FIG. 15 executing machine executable instructions such as those implemented by at least blocks 1005, 1102, 1104, 1015, 1310 of FIGS. 10, 11, and/or 13. In some examples, the interface circuitry 210 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the interface circuitry 210 may be instantiated by any other combination of hardware, software, and/or firmware. For example, the interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example store dictionary generator circuitry 220 updates and/or generates a dictionary relevant to store observations utilized by a machine-learning (ML) and/or artificial intelligence (AI) model to more accurately perform word embedding and/or parse an input question from a field auditor. In examples disclosed herein, a vocabulary of an ML/AI model defines a set of words that the model is able to recognize (e.g., as used in Natural Language Processing (NLP) models, Visual Question Answering (VQA) models, etc.). When a dictionary used by an NLP and/or VQA model is updated to include a wider group of words relevant to a specific type of industry in which the model is to be deployed, an accuracy measure of the trained model experiences a large increase as opposed to a model with a more limited and/or irrelevant dictionary. For example, if a dictionary associated with a sports industry included words such as “apple”, “banana”, “pear”, etc., the associated ML/AI that employs that dictionary would produce inaccurate and/or irrelevant results in response to questions asked about sporting teams, athletes, etc. In examples disclosed herein, the store dictionary generator circuitry 220 may obtain a new vocabulary from a datastore (e.g., datastore 120 of FIG. 1) and/or an external computing device (e.g., external electronic systems 130), via a network (e.g., network 128) and augment the preexisting dictionary with the new vocabulary to generate an updated dictionary. Additionally, in examples disclosed herein, a type of dictionary of a set of dictionaries may be marked and/or otherwise flagged for use in association with a particular store environment, retail location, retail industry type, and/or field auditor identity. That is, for example, a particular dictionary of words relevant to a particular store may be indicated as such to account for any field auditor questions related to that particular store. In another example, a dictionary may follow (e.g., be flagged for use by) a particular field auditor, with their language and/or regional preferences carrying over into any retail environment they may visit for field auditing, allowing them to comfortably ask questions in their own language. In some examples, the example store dictionary generator circuitry 220 is instantiated by processor circuitry executing store dictionary generator circuitry 220 instructions and/or configured to perform operations such as those represented by the flowcharts of FIGS. 10-13.

In some examples, the example store dictionary generator circuitry 220 includes means for updating and/or generating an ML/AI model dictionary with a vocabulary specific to and/or including store observations. For example, the means for updating and/or generating an ML/AI model dictionary with a vocabulary specific to and/or including store observations may be implemented by store dictionary generator circuitry 220. In some examples, the store dictionary generator circuitry 220 may be instantiated by processor circuitry such as the example processor circuitry 1412 of FIG. 14. For instance, the store dictionary generator circuitry 220 may be instantiated by the example microprocessor 1500 of FIG. 15 executing machine executable instructions such as those implemented by at least blocks 1005, 1104 of FIGS. 10, and/or 11. In some examples, the store dictionary generator circuitry 220 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the store dictionary generator circuitry 220 may be instantiated by any other combination of hardware, software, and/or firmware. For example, the store dictionary generator circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example question processor circuitry 230 obtains a set of question templates (e.g., question templates 295) representing a set of question formats from which question-answer pairs are generated by the example question-answer pair generator circuitry 250. In examples disclosed herein, an example question template may be “how many { } are there?”. Using this example question template, example questions such as “how many bananas are there”, “how many wine bottles are there”, “how many apples are there”, etc. may be generated (e.g., by the question-answer pair generator circuitry 250). In examples disclosed herein, any number of the question templates (e.g., question templates 295) may be obtained from an example datastore (e.g., datastore 292, datastore 120 of FIG. 1, etc.), database, Internet source, network, etc. In some examples, the example question processor circuitry 230 is instantiated by processor circuitry executing question processor circuitry 230 instructions and/or configured to perform operations such as those represented by the flowcharts of FIGS. 10-13.

In some examples, the example question processor circuitry 230 includes means for updating and/or generating an ML/AI model dictionary using a vocabulary specific to and/or including store observations. For example, the means for updating and/or generating an ML/AI model dictionary using a vocabulary specific to and/or including store observations may be implemented by question processor circuitry 230. In some examples, the question processor circuitry 230 may be instantiated by processor circuitry such as the example processor circuitry 1412 of FIG. 14. For instance, the question processor circuitry 230 may be instantiated by the example microprocessor 1500 of FIG. 15 executing machine executable instructions such as those implemented by at least blocks 1005, 1108 of FIGS. 10, and/or 11. In some examples, the question processor circuitry 230 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the question processor circuitry 230 may be instantiated by any other combination of hardware, software, and/or firmware. For example, the question processor circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example store image processor circuitry 240 obtains a set of store observation images and further characterizes the store observation images as being whole images or cropped images. In examples disclosed herein, the store image processor circuitry 240 may obtain the store observation images from the store dataset 294 that was obtained by the interface circuitry 210. In some examples, the example store image processor circuitry 240 is instantiated by processor circuitry executing question processor circuitry 230 instructions and/or configured to perform operations such as those represented by the flowcharts of FIGS. 10-13.

In some examples, the example store image processor circuitry 240 includes means for obtaining and characterizing a set of store observation images as whole and/or cropped images. For example, the means for obtaining and characterizing a set of store observation images and whole and/or cropped images may be implemented by store image processor circuitry 240. In some examples, the store image processor circuitry 240 may be instantiated by processor circuitry such as the example processor circuitry 1412 of FIG. 14. For instance, the store image processor circuitry 240 may be instantiated by the example microprocessor 1500 of FIG. 15 executing machine executable instructions such as those implemented by at least blocks 1005, 1106 of FIGS. 10, and/or 11. In some examples, the store image processor circuitry 240 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the store image processor circuitry 240 may be instantiated by any other combination of hardware, software, and/or firmware. For example, the store image processor circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example question-answer pair generator circuitry 250 generates (e.g., by way of the example ML model(s) 293), a set of question-answer pairs, based on an associated loss score. In examples disclosed herein, for each store observation image obtained by the example interface circuitry 210 in the store dataset 294, after characterization as a whole or cropped image by the example store image processor circuitry 240, the question-answer pair generator circuitry 250 selects a subset of the question templates 295 (e.g., generated by the question processor circuitry 230) based on the determined characterization of the given store observation image. For example, if a particular store observation image is classified as a whole image by the store image processor circuitry 240, a set of questions pertaining to a wholistic shelf view may be included (e.g., “how many shelves are there?”, “how many different categories are in this image?”, “what is the number of horizontal shelves?”, etc.), instead of more particular product-specific questions (e.g., “what brand is this product?”, “what size is this product?”, etc.) that would be included if the particular image were characterized as a cropped image.

In some examples, the question templates 295 obtained by the interface circuitry 210 (e.g., as part of the store dataset 294) may be flagged and/or otherwise marked for association with whole and/or cropped images. That is, for example, a first subset of question templates directed towards cropped images of the store observation images would be identifiable against a second subset of question templates directed towards whole images of the store observations images, for selection by the question-answer pair generator circuitry 250. Furthermore, in examples disclosed herein, metadata associated with the question templates (e.g., obtained as part of the store dataset 294) may mark and/or otherwise flag for use a particular subset of question templates applicable for a particular retail location, field auditor, region, retail industry, etc. That is, for example, should a field auditor visit a particular retail chain store in Spain, an associated set of question templates relevant to that particular industry, region, language, etc. would be flagged for selection.

For each store observation image, the question-answer pair generator circuitry 250 selects the desired subset of question templates based on the characterization of the given store observation image made by the store image processor circuitry 240 and inputs the subset of question templates to machine-learning (ML)/artificial intelligence (AI) model(s) (e.g., the ML model(s) 293). The question-answer pair generator circuitry 250 causes the ML model(s) 293 to iterate through a number of permutations of question-answer pairs, and selects those with a minimum associated loss score for use with each image, based on a ground truth answer associated with each question. For example, in operation, the ML model(s) 293 may take a whole image of a set of store shelves and a question of “how many shelves are there?” to generate an answer of “4” (e.g., based on a loss score associated with a ground truth answer to that question, as provided in the example store dataset 294). The question-answer pair generator circuitry 250 then stores (e.g., in the datastore 292) “how many shelves are there?” and “4” as a question-answer pair associated with that particular store observation image for use in deployment of the ML model(s) 293. In some examples, the example question-answer pair generator circuitry 250 is instantiated by processor circuitry executing question-answer pair generator circuitry 250 instructions and/or configured to perform operations such as those represented by the flowcharts of FIGS. 10-13.

In some examples, the example question-answer pair generator circuitry 250 includes means for generating question-answer pairs using the ML model(s) 293 and associated ground truth values for each characterized store observation image. For example, the means for generating question-answer pairs using the ML model(s) 293 and associated ground truth values for each characterized store observation image may be implemented by question-answer pair generator circuitry 250. In some examples, the question-answer pair generator circuitry 250 may be instantiated by processor circuitry such as the example processor circuitry 1412 of FIG. 14. For instance, the question-answer pair generator circuitry 250 may be instantiated by the example microprocessor 1500 of FIG. 15 executing machine executable instructions such as those implemented by at least blocks 1005, 1110, 1112 of FIGS. 10, and/or 11. In some examples, the question-answer pair generator circuitry 250 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the question-answer pair generator circuitry 250 may be instantiated by any other combination of hardware, software, and/or firmware. For example, the question-answer pair generator circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example model trainer circuitry 260 trains the ML model(s) 293 using the question-answer pairs generated by the question-answer pair generator circuitry 250 to ensure any combination of words adequately resembling a question included in the question-answer pairs generated by the question-answer pair generator circuitry 250 (e.g., as measured by a loss score associated with training of the ML model(s) 293) is recognized as a natural language representation of that particular question. For example, a question such as “how many shelves are there?” that is part of a question-answer pair generated by the question-answer pair generator circuitry 250 may have the same answer as and/or closely resemble “what are the number of shelves?”, “what number of shelves are there?”, etc. The model trainer circuitry 260, in examples disclosed herein, broadens the recognizability of each question-answer pair to account for variations in natural language, dialects, regions, etc. In some examples, the example model trainer circuitry 260 is instantiated by processor circuitry executing model trainer circuitry 260 instructions and/or configured to perform operations such as those represented by the flowcharts of FIGS. 10-13.

In some examples, the example model trainer circuitry 260 includes means for training the ML model(s) 293 to account for natural language variations in the question-answer pairs generated by the question-answer pair generator circuitry 250. For example, the means for training the ML model(s) 293 to account for natural language variations in the question-answer pairs generated by the question-answer pair generator circuitry 250 may be implemented by model trainer circuitry 260. In some examples, the model trainer circuitry 260 may be instantiated by processor circuitry such as the example processor circuitry 1412 of FIG. 14. For instance, the model trainer circuitry 260 may be instantiated by the example microprocessor 1500 of FIG. 15 executing machine executable instructions such as those implemented by at least blocks 1010, 1202-1214 of FIGS. 10 and/or 12. In some examples, the model trainer circuitry 260 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the model trainer circuitry 260 may be instantiated by any other combination of hardware, software, and/or firmware. For example, the mode trainer circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example query analyzer circuitry 270 obtains a query (e.g., from a user, a field auditor, etc.) regarding store observation images and parses the question and store observation image to the example model execution circuitry 280 to perform word embedding, image classification, etc. using the ML model(s) 293. In examples disclosed herein, the query may be obtained via a network (e.g., the network 128 of FIG. 1) from a user device, external computing system (e.g., the external electronic system 130 of FIG. 1), etc. In examples disclosed herein, the query analyzer circuitry 270 distinguishes a store observation image input from a natural language question input as part of the obtained query and passes the natural language question to the ML/AI model after dictionary expansion by the store dictionary generator circuitry 220 for word embedding. Additionally, in examples disclosed herein, any word embedding and/or image classification techniques can be used to input the question and store observation image, respectively, of the obtained query. In some examples, the example query analyzer circuitry 270 is instantiated by processor circuitry executing query analyzer circuitry 270 instructions and/or configured to perform operations such as those represented by the flowcharts of FIGS. 10-13.

In some examples, the example query analyzer circuitry 270 includes means for obtaining and processing a query regarding a store observation image, to pass the question and associated store observation image to the model execution circuitry 280 for deployment. For example, the means for obtaining and processing a query regarding a store observation image, to pass the question and associated store observation image to the model execution circuitry 280 for deployment may be implemented by query analyzer circuitry 270. In some examples, the query analyzer circuitry 270 may be instantiated by processor circuitry such as the example processor circuitry 1412 of FIG. 14. For instance, the query analyzer circuitry 270 may be instantiated by the example microprocessor 1500 of FIG. 15 executing machine executable instructions such as those implemented by at least blocks 1015, 1302-1304 of FIGS. 10 and/or 13. In some examples, the query analyzer circuitry 270 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the query analyzer circuitry 270 may be instantiated by any other combination of hardware, software, and/or firmware. For example, the query analyzer circuitry 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example model execution circuitry 280 inputs the question and associated store observation image distinguished by the query analyzer circuitry 270 to the ML model(s) 293 to generate a query response. In examples disclosed herein, the ML model(s) 293 performs word embedding using the question (e.g., based on the updated dictionary generated by the store dictionary generator circuitry 200) and/or performs image classification on the store observation image further provided as input to the model. In examples disclosed herein, any method and/or technique for word embedding and/or image classification may be utilized by the ML/AL model (e.g., ML model(s) 293). Once the ML/AI model processes the input question and store observation image, the model outputs an answer to that question. For example, an input of a whole store observation image including four horizontal shelves and an associated question of “how many shelves are there?” would yield an answer of “4”. In some examples, the example model execution circuitry 280 is instantiated by processor circuitry executing model execution circuitry 280 instructions and/or configured to perform operations such as those represented by the flowcharts of FIGS. 10-13.

In some examples, the model execution circuitry 280 includes means for utilizing an ML/AI model to perform word embedding on a question and/or to perform image classification on an associated store observation image to output an answer to the query. For example, the means for utilizing an ML/AI model to perform word embedding on a question and/or to perform image classification on an associated store observation image to output an answer to the query may be implemented by model execution circuitry 280. In some examples, the model execution circuitry 280 may be instantiated by processor circuitry such as the example processor circuitry 1412 of FIG. 14. For instance, the model execution circuitry 280 may be instantiated by the example microprocessor 1400 of FIG. 14 executing machine executable instructions such as those implemented by at least blocks 1015, 1306 of FIGS. 10 and/or 13. In some examples, the model execution circuitry 280 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the model execution circuitry 280 may be instantiated by any other combination of hardware, software, and/or firmware. For example, the model execution circuitry 280 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example query response generator circuitry 290 outputs the answer generated by the model execution circuitry 280 (e.g., to a user). In examples disclosed herein, the answer may be displayed via a graphical user interface (e.g., the user interface 126 of FIG. 1) to a user and/or may be included as part of a larger report. In some examples, the example query response generator circuitry 290 is instantiated by processor circuitry executing query response generator circuitry 290 instructions and/or configured to perform operations such as those represented by the flowcharts of FIGS. 10-13.

In some examples, the query response generator circuitry 290 includes means for outputting the answer to the query generated by the model execution circuitry 280 (e.g., to a user). For example, the means for outputting the answer to the query generated by the model execution circuitry 280 (e.g., to a user) may be implemented by query response generator circuitry 290. In some examples, the query response generator circuitry 290 may be instantiated by processor circuitry such as the example processor circuitry 1412 of FIG. 14. For instance, the query response generator circuitry 290 may be instantiated by the example microprocessor 1500 of FIG. 15 executing machine executable instructions such as those implemented by at least blocks 1015, 1308 of FIGS. 10 and/or 13. In some examples, the query response generator circuitry 290 may be instantiated by hardware logic circuitry, which may be implemented by an ASIC, XPU, or the FPGA circuitry 1600 of FIG. 16 structured to perform operations corresponding to the machine readable instructions. Additionally, or alternatively, the query response generator circuitry 290 may be instantiated by any other combination of hardware, software, and/or firmware. For example, the query response generator circuitry 290 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the accelerator compiler 104 is illustrated in FIG. 2 one or more of the elements, processes and/or devices illustrated in FIG. 2 may be combined, divided, re-arranged, omitted, eliminated and/or implemented in any other way. Further, the example interface circuitry 210, the example store dictionary generator circuitry 220, the example question processor circuitry 230, the example store image processor circuitry 240, the example question-answer pair generator circuitry 250, the example model trainer circuitry 260, the example query analyzer circuitry 270, the example model execution circuitry 280, the example query response generator circuitry 290, and/or, more generally, the accelerator compiler 104 of FIGS. 1 and/or 2 may be implemented by hardware, software, firmware and/or any combination of hardware, software and/or firmware. Thus, for example, any of the example interface circuitry 210, the example store dictionary generator circuitry 220, the example question processor circuitry 230, the example store image processor circuitry 240, the example question-answer pair generator circuitry 250, the example model trainer circuitry 260, the example query analyzer circuitry 270, the example model execution circuitry 280, the example query response generator circuitry 290, and/or, more generally, the example accelerator compiler 104 of FIGS. 1 and/or 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example accelerator compiler 104 of FIGS. 1 and/or 2 may include one or more elements, processes, and/or devices in addition to, or instead of, those illustrated in FIG. 2, and/or may include more than one of any or all of the illustrated elements, processes and devices.

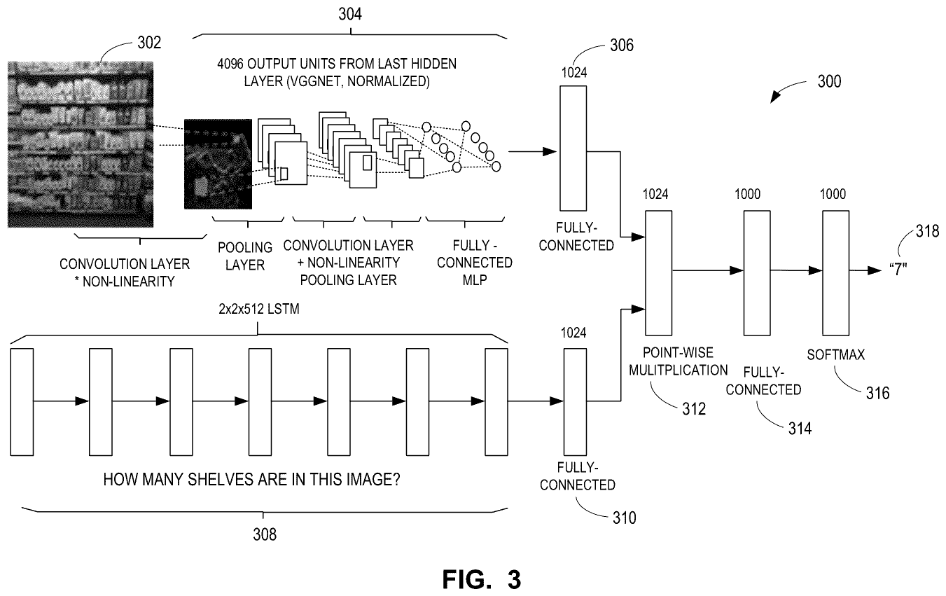

FIG. 3 illustrates an example machine-learning (ML) and/or artificial intelligence (AI) model framework 300 for receiving a query regarding a store observation image and outputting a response to the query. The ML/AI model framework 300 includes an example input store observation image 302, an example image classification layer 304, an example image fully-connected layer 306, an example input word-embedded question 308, an example question fully-connected layer 310, an example point-wise multiplication layer 312, an example aggregate fully-connected layer 314, an example softmax layer 316, and an example query response 318.

The example input store observation image 302 is passed as input to the ML/AI model utilized by the ML/AI model framework 300 and classified by the image classification layer 304. In examples disclosed herein, the example input store observation image 302 may be any type of image (e.g., of a store shelf, a particular product, etc.) taken by a field auditor on a personal computing device, a personal image capturing device, etc. In some examples, the ML/AI model may account for blurry and/or otherwise incompatible images (e.g., images where attempted classification fails) by selecting a pre-captured image of the particular store shelf in that particular retail location for use (e.g., through similarity comparison). In addition, in some examples, the field auditor may select from a preexisting set of store observation images (e.g., particular to the retail location in which they are actively auditing) to select their relevant image associated with their question. In examples disclosed herein, any image classification technique may be utilized by the image classification layer 304, which may further include sub-layers such as a pooling layer, a convolution layer combined with a non-linearity pooling layer, and a fully-connected multilayer perceptron (MLP) (e.g., a collection of interleaved fully-connected layers and non-linearity layers). The image classification layer 304, in examples disclosed herein, may identify and/or classify a type of object in the input store observation image 302 (e.g., a shelf, a banana, etc.) for selection later as (part of) the query response 318, based on the input word-embedded question 308. The example image fully-connected layer 306 represents a layer of the neural network (e.g., CNN) where every input neuron is connected to an output neuron (e.g., representing a classified store observation image).

The example input word-embedded question 308 represents an embedded and/or encoded input question associated with the input store observation image 302, such as “how many shelves are in this image?”. In examples disclosed herein, any word embedding and/or encoding technique may be used to represent the input word-embedded question 308, such as one-hot encoding, etc. The example question fully-connected layer 310 represents a layer of the neural network (e.g., CNN) where every input neuron is connected to an output neuron (e.g., representing an embedded input question).

The image fully-connected layer 306 and the question fully-connected layer 310 are then, in examples disclosed herein, combined using point-wise multiplication (e.g., multiplication of each element in the image fully-connected layer 306 by each element in the question fully-connected layer 310) into a point-wise multiplication layer 312. The point-wise multiplication layer 312, in examples disclosed herein, reconciles each classified element of the input store observation image 302 with the input word-embedded question 308. The point-wise multiplication layer 312 is then converted to the example aggregate fully-connected layer 314. In examples disclosed herein, the aggregate fully-connected layer 314 represents a fully-connected layer of classified objects and word embeddings. The aggregate fully-connected layer 314 is then converted into a softmax layer 316 (e.g., by the model execution circuitry 280 of FIG. 2). In examples disclosed herein, the softmax layer 316 represents a layer of the neural network in which a distribution of answers according to probability (e.g., as calculated using a softmax function) is shown. From the probability distribution of answers in the softmax layer 316, the query response 318 is selected. In examples disclosed herein, the query response 318 is selected to be the answer with the highest associated probability, as calculated in the softmax layer 316 (e.g., by the model execution circuitry 280 of FIG. 2).

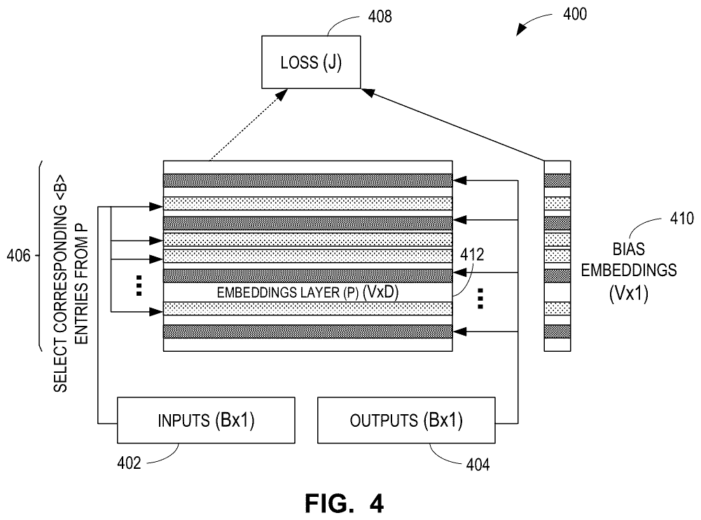

FIG. 4 illustrates an example word embedding architecture 400 which may be utilized by the machine-learning (ML) and/or artificial intelligence (AI) model framework 300 of FIG. 3 (e.g., to perform word embedding on the example input word-embedded question 308 of FIG. 3) during training of the model. In examples disclosed herein, the process of transforming text into vectors of numbers is known as word embedding, and the words to be processed and matched by an ML/AI model and/or an NLP system are converted into one-hot vectors that contain all the lexical and/or semantic information from the original words. In examples disclosed herein, if words (e.g., from an input question) are represented as vectors, there is a limit to the number of words that an NLP and/or ML/AI model can recognize. As explained hereinabove, the particular group of words which the model can recognize is known as a vocabulary. Any other word outside of this vocabulary will be ignored or will be attributed as a base vector associated with no meaning.

The example word embedding architecture 400 of FIG. 4 includes an example embedding input 402, an example embedding output 404, an example set of encoded words 406, an example loss score 408, an example embeddings layer 412, and an example set of bias embeddings 410. In examples disclosed herein, the example embedding input 402 represents an encoded set of words from an input question (e.g., “how many shelves are in this image?”). In examples disclosed herein, one-hot encoding is typically used to represent the set of words within an input question, however, any other type of encoding algorithm may be used. The encoded words are then represented as the set of encoded words 406, within the architecture of the ML/AI model. In examples disclosed herein, a subset of encoded words may be selected from the embedding input 402 based on relevance to the NLP model (e.g., filler words such as “the” and “a” may be excluded). The example embeddings layer 412 then runs an ML/AI model to determine a set of possible answers (e.g., ranked by an associated probability metric). The most probable answer of that set of possible answers is selected for comparison against the bias embeddings 410, which, in examples disclosed herein, represent a ground truth set of answers for the input question. The loss score 408 is associated with each possible answer, as determined against the bias embeddings 410, and if the loss score 418 satisfies a threshold value, the answer is represented in the embeddings layer 412 for use in deployment of the model. If the loss score 418 does not satisfy the threshold value, the NLP model continues to iterate through the set of possible answers to determine the next best answer (e.g., based on the associate probability metric) for comparison against the bias embeddings 410.

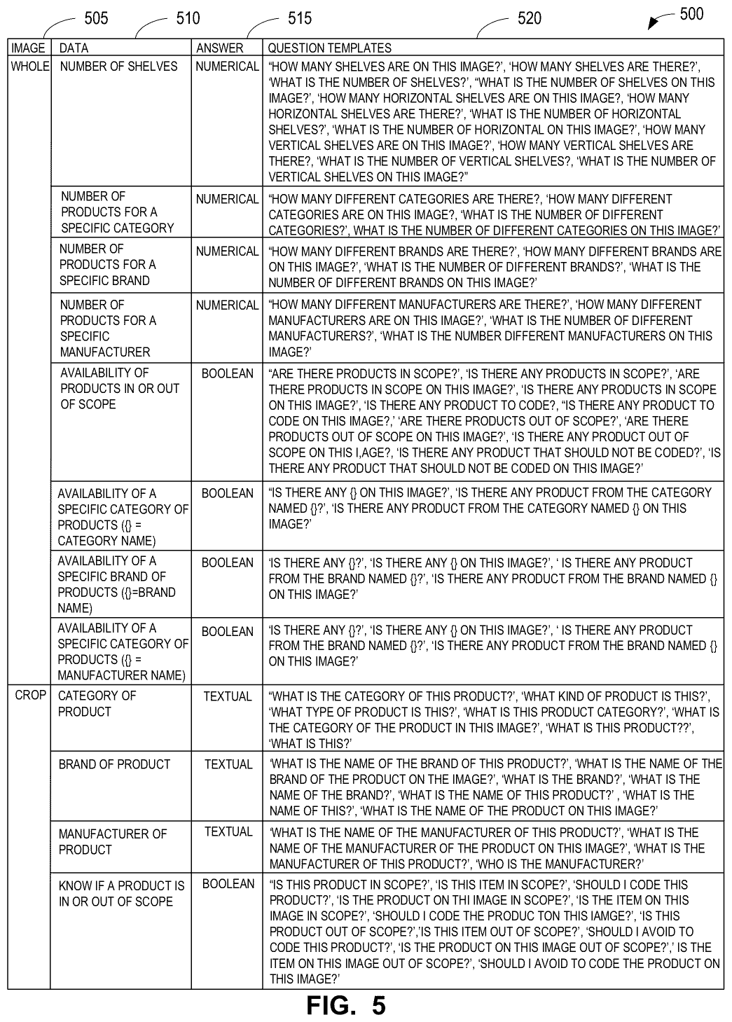

FIG. 5 illustrates an example generated set of question-answer templates 500, using which an ML/AI model may generate question-answer pairs (e.g., using the question-answer pair generator circuitry 250 of FIG. 2). The generated set of question-answer templates 500 includes an example image category 505, an example data category 510, an example answer type 515, and an example set of templates 520. As described hereinabove, the set of templates 520 may be each uniquely associated with the image category 505, the data category 510, and/or the answer type 515, for selection based on an image characterization. The image category 505, in examples disclosed herein, corresponds to a determination made (e.g., by the store image processor circuitry 240) as to whether the image is a cropped image or a whole image. The data category 510 may represent, for example, a number of shelves, a number of products for a specific category, etc., and the answer type 515 may be “numerical”, “Boolean”, “textual”, etc. The set of templates 520 then corresponds to the combination of image characteristics, from which the question-answer pair generator circuitry 250 of FIG. 2 can determine question-answer pairs.

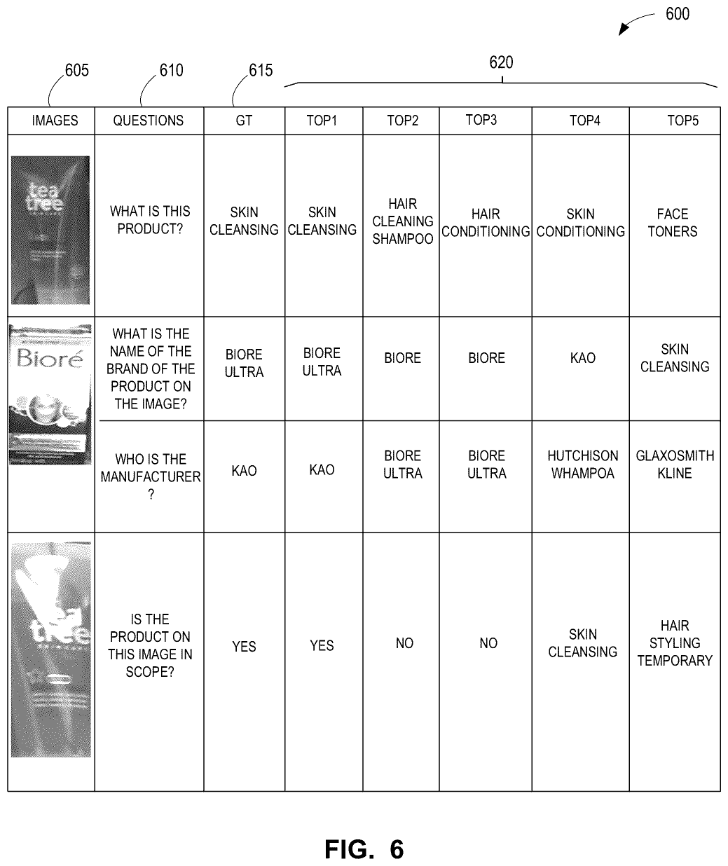

FIG. 6 illustrates an example answer distribution over cropped images 600, which includes an example set of cropped images 605, an example set of associated input questions 610, an example ground truth answer 615, and an example set of possible cropped image answers 620. The set of cropped images 605 is a selection of store observation images characterized (e.g., by the store image processor circuitry 240 of FIG. 2) to be cropped images. The example set of associated input questions 610 represent a set of questions associated with each cropped image (e.g., that a field auditor has asked along with the cropped image). The ground truth answer 615 represents, for training purposes of the ML/AI model, the ground truth answer to the set of associated input questions 610, and the set of possible cropped image answers 620 represents a set of possible answers (e.g., ordered based on probability, where “top 1” represents the most probable answer, and “top 5” represents the least probable of the selected answers), as determined by the ML/AI model (e.g., by the question-answer pair generator circuitry 250 of FIG. 2). In examples disclosed herein, the question-answer pair generator circuitry 250 of FIG. 2 would then select the most probable answer of the set of possible cropped image answers 620 to generate a question-answer pair.

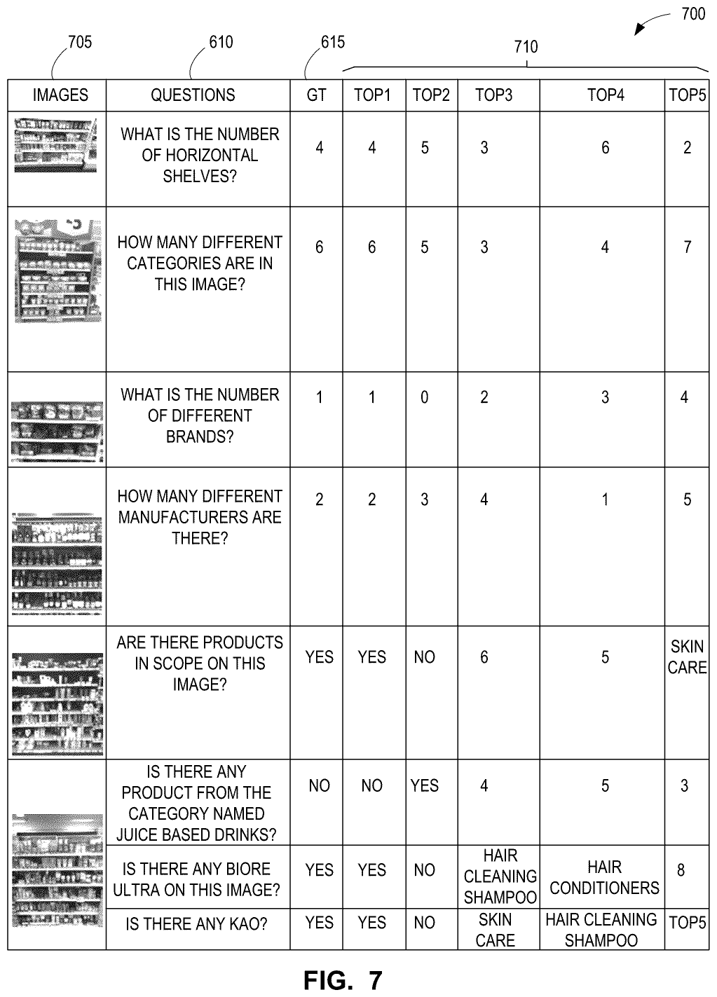

FIG. 7 illustrates an example answer distribution over whole images 700, which includes an example set of whole images 705, an example set of associated input questions 610, an example ground truth answer 615, and an example set of possible whole image answers 710. The set of whole images 705 is a selection of store observation images characterized (e.g., by the store image processor circuitry 240 of FIG. 2) to be whole images. The example set of associated input questions 610 represent the set of questions associated with each whole image (e.g., that a field auditor has asked along with the whole image). The ground truth answer 615 represents, for training purposes of the ML/AI model, the ground truth answer to the set of associated input questions 610, and the set of possible whole image answers 710 represents a set of possible answers (e.g., ordered based on probability, where “top 1” represents the most probable answer, and “top 5” represents the least probable of the selected answers), as determined by the ML/AI model (e.g., by the question-answer pair generator circuitry 250 of FIG. 2). In examples disclosed herein, the question-answer pair generator circuitry 250 of FIG. 2 would then select the most probable answer of the set of possible whole image answers 710 to generate a question-answer pair.

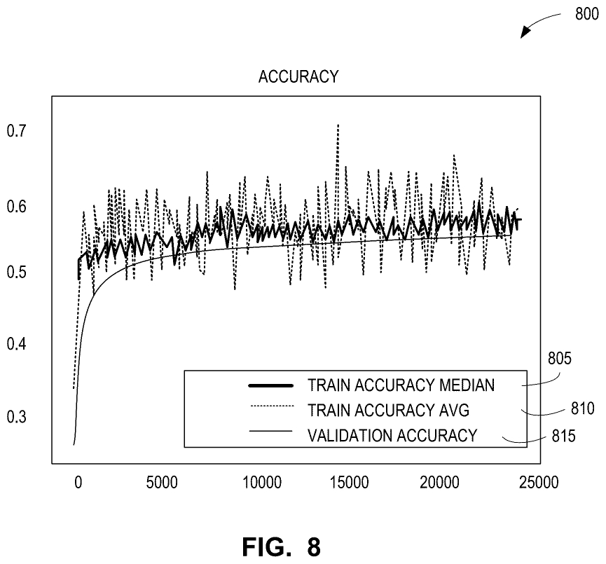

FIG. 8 illustrates an example model accuracy graph 800 of the ML/AI model, including an example train accuracy median 805, an example train accuracy average 810, and an example validation accuracy 820. In examples disclosed herein, an accuracy value of an ML/AI model is calculated by dividing a number of correct predictions made by the model (e.g., as determined against a set of ground truth values) by the total number of samples, however, any other type of method may be used to determine accuracy of the ML/AI model. The validation accuracy 820 of the ML/AI model, in examples disclosed herein, is a metric that represents the generalization ability of the model (e.g., across different store datasets, etc.), which may be determined during testing of the model once training is complete. In the example model accuracy graph 800 of FIG. 8, the trained ML/AI model shows a high train accuracy median 805 and validation accuracy 820 (e.g., an accuracy greater than 50%), indicating good model performance in deployment.

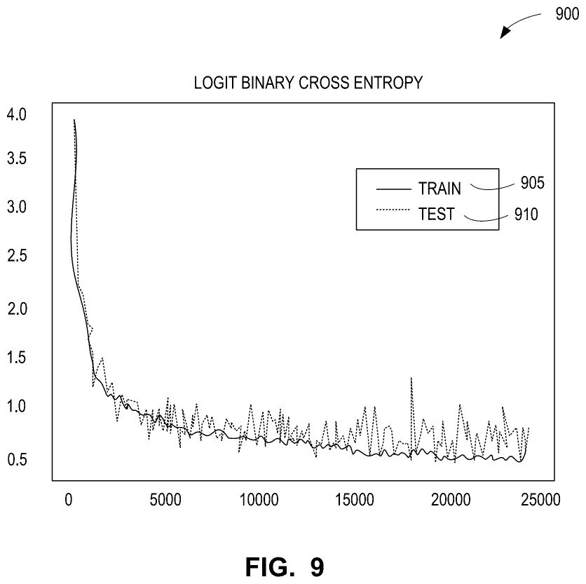

FIG. 9 illustrates an example model loss graph 900, including an example training loss 905 and an example testing loss 910. In examples disclosed herein, the lower the loss score, the better the ML/AI model performance. In the illustrated example model loss graph 900, the training loss 905 and testing loss 910 trend close to zero (e.g., indicating a good loss score) as the number of input samples increases, further indicating good ML/AI model performance.

Flowcharts representative of example machine readable instructions, which may be executed to configure processor circuitry to implement the accelerator compiler 104 of FIGS. 1 and/or 2, are shown in FIGS. 10-13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 10-13, many other methods of implementing the example accelerator compiler 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 10-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 10 is a flowchart representative of example machine readable instructions and/or example operations 1000 that may be executed and/or instantiated by processor circuitry in conjunction with the product accelerator compiler 104 of FIGS. 1 and/or 2 to provide responses to store observation queries using trained machine-learning (ML)/artificial intelligence (AI) model(s).

At block 1005, the store dictionary generator circuitry 220 of FIG. 2 generates the store observation dataset, as described further in conjunction with FIG. 11.

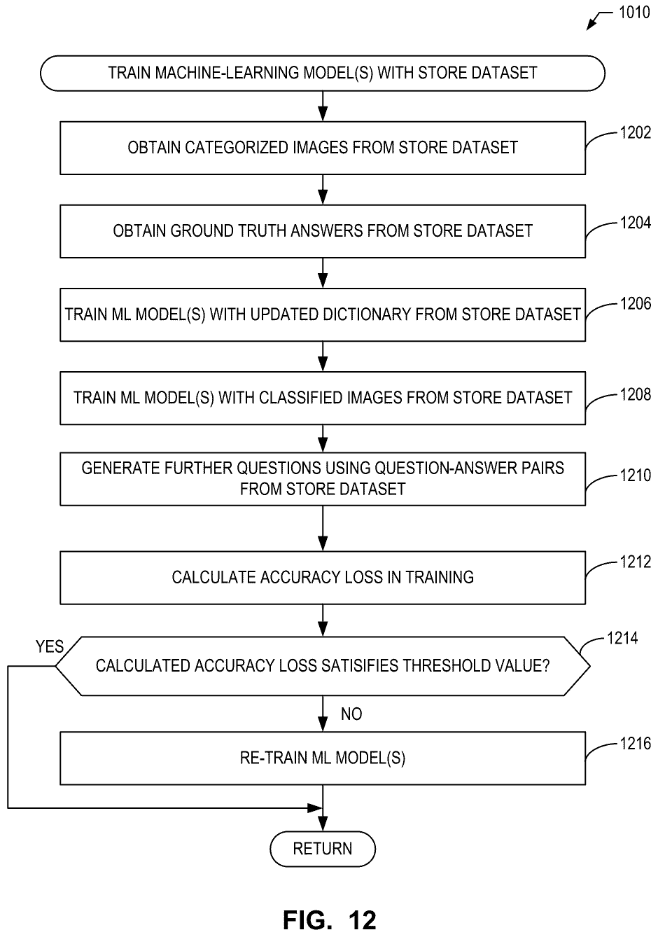

At block 1010, the model trainer circuitry 260 of FIG. 2 trains machine-learning (ML) model(s) with the store observation dataset, as described further in conjunction with FIG. 12.

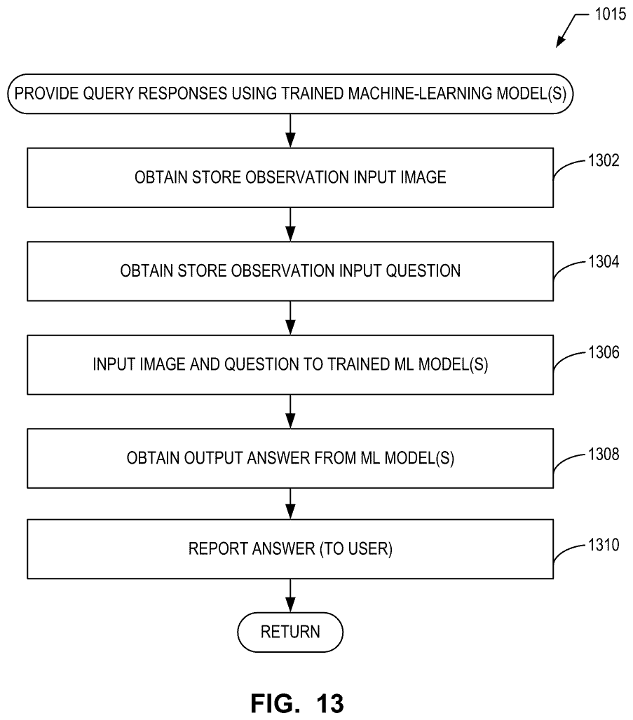

At block 1015, the query response generator circuitry 290 of FIG. 2 provides query responses using the trained machine-learning (ML) model(s), as described further in conjunction with FIG. 13.

FIG. 11 is a flowchart representative of example machine readable instructions and/or example operations 1005 that may be executed and/or instantiated by processor circuitry in conjunction with the product accelerator compiler 104 of FIGS. 1 and/or 2 to generate a store observation dataset.

At block 1102, the store dictionary generator circuitry 220 of FIG. 2 obtains a vocabulary structure or a dictionary (e.g., a vocabulary data structure, vocabulary data file, etc.) for a given store, set of stores, retail industry, etc. As explained hereinabove, in examples disclosed herein, the vocabulary structure or dictionary associated with any given store may have associated metadata indicating particular characteristics of the vocabulary represented in the structure/dictionary. In some examples, metadata characteristics include a language type, a store type, a geographic region, etc. Therefore, in those examples, the store dictionary generator circuitry 220 would select the vocabulary structure/dictionary indicated for use for the particular store, set of stores, retail industry, field auditor, etc.

In some examples, the store dictionary generator circuitry 220 obtains metadata from any number of candidate dictionaries and compares the metadata against context data, in which the context data may include information corresponding to a current location of a store, a current language corresponding to the store, a currency used at the current location, a type of store (e.g., a pharmacy, a grocery store, a convenience store, a beverage store, etc.). The store dictionary generator circuitry 220 compares the metadata for a candidate dictionary of interest against the context data to determine a similarity metric and/or threshold. For instance, the dictionary generator circuitry 220 compares a number of matches between the metadata and the context data in an effort to determine the similarity metric, such as whether the dictionary language is the same/different, whether the dictionary store type is same/different, whether the dictionary currency type is same/different, etc.

In examples disclosed herein, a vocabulary structure of an ML/AI model defines a set of words that the model is able to recognize (e.g., as used in Natural Language Processing (NLP) models, Visual Question Answering (VQA) models, etc.). When a dictionary used by an NLP and/or VQA model is updated to include a wider group of words relevant to a specific type of industry in which the model is to be deployed, an accuracy measure of the trained model experiences a large increase (e.g., improvement) as opposed to a model with a more limited and/or irrelevant dictionary. For example, if a dictionary associated with a sports industry included words such as “apple”, “banana”, “pear”, etc., the associated ML/AI that employs that dictionary would produce inaccurate and/or irrelevant results in response to questions asked about sporting teams, athletes, etc. In examples disclosed herein, the store dictionary generator circuitry 220 may obtain a new vocabulary from a datastore (e.g., datastore 120 of FIG. 1) and/or an external computing device (e.g., external electronic systems 130), via a network (e.g., network 128).

At block 1104, the store dictionary generator circuitry 220 of FIG. 2 augments the ML/AI model dictionary to include the vocabulary obtained (e.g., by the store dictionary generator circuitry 220).

At block 1106, the interface circuitry 210 obtains a set of store observation images for a particular store, set of stores, retail locations, retail industry, etc. In examples disclosed herein, the interface circuitry 210 may obtain the set of store observation images from the example datastore 120, the example external computing systems 130 of FIG. 1, etc. In examples disclosed herein, this source may be any type of database, Internet source, etc. Additionally, in examples disclosed herein, the interface circuitry 210 may receive and/or transmit data to a network or other parts of the electronic system 102 of FIG. 1, such as the acceleration circuitry 108, 110 of FIG. 1. In some examples, the interface circuitry 210 may also be the interface and/or cable from a laptop to a GPU and/or FPGA to configure an operation such as a loading of an image.

At block 1108, the store image processor circuitry 240 of FIG. 2 categorizes the store observation images obtained by the interface circuitry 210 at block 1104 to determine whether each of the store observation images are cropped images or whole images. In examples disclosed herein, the store observation images, as obtained by the interface circuitry 210, may be pre-marked for categorization, or the store image processor circuitry 240 may employ any type of image classification technique to determine whether the image is whole or cropped.

At block 1110, the interface circuitry 210 of FIG. 2 obtains a set of question templates for a store, a set of stores, a retail location, a retail industry, etc. In examples disclosed herein, the interface circuitry 210 may obtain the set of question templates from the example datastore 120, the example external computing systems 130 of FIG. 1, etc. In examples disclosed herein, this source may be any type of database, Internet source, etc. Additionally, in examples disclosed herein, the interface circuitry 210 may receive and/or transmit data to a network or other parts of the electronic system 102 of FIG. 1, such as the acceleration circuitry 108, 110 of FIG. 1. In some examples, the interface circuitry 210 may also be the interface and/or cable from a laptop to a GPU and/or FPGA. Furthermore, in examples disclosed herein, the set of question templates may be flagged and/or otherwise indicated for association with a certain type of image. That is, for example, a set of question templates may only apply to whole images and would be so indicated by a flag, a marker, etc. A set of question templates that only apply to cropped images would be similarly indicated.

At block 1112, the question-answer pair generator circuitry 250 of FIG. 2 generates a set of question-answer pairs using the question templates obtained by the interface circuitry 210 at block 1110. In examples disclosed herein, an example question template may be “how many { } are there?”. Using this example question template, example questions such as “how many bananas are there”, “how many wine bottles are there”, “how many apples are there”, etc. may be generated (e.g., by the question-answer pair generator circuitry 250). In examples disclosed herein, for each store observation image, the question-answer pair generator circuitry 250 selects the desired subset of question templates based on the characterization of the given store observation image made by the store image processor circuitry 240 and inputs the subset of question templates to machine-learning (ML)/artificial intelligence (AI) model(s) (e.g., the ML model(s) 293). The question-answer pair generator circuitry 250 causes the ML model(s) 293 to iterate through a number of permutations of question-answer pairs and selects those with a minimum associated loss score for use with each image, based on a ground truth answer associated with each question. Because the question-answer pair generator circuitry 250 generates the set of question-answer pairs using the question templates deemed relevant to the context of the auditor, reliance upon auditor (human) discretion of the type of data to acquire is not needed. Reduction on the reliance of human discretion also reduces data collection error and waste. Furthermore, an automated process for efficient generation of question-answer pairs further reduces computational inefficiency and/or resource wastage. That is, automatic generation of question-answer pair permutations by an ML/AI model allows for the handling of much higher volumes of data at a much faster rate, thus promoting computational efficiency.

At block 1114, the question-answer pair generator circuitry 250 of FIG. 2 stores the question-answer pairs generated at block 1112 in a larger store observation dataset.

FIG. 12 is a flowchart representative of example machine readable instructions and/or example operations 1010 that may be executed and/or instantiated by processor circuitry in conjunction with the product accelerator compiler 104 of FIGS. 1 and/or 2 to train machine-learning (ML) model(s) with the store observation dataset.

At block 1202, the model trainer circuitry 260 of FIG. 2 obtains the store observation images, categorized by type (e.g., “whole” or “cropped”), from the store dataset.

At block 1204, the model trainer circuitry 260 of FIG. 2 further obtains a set of ground truth answers from the store dataset. In examples disclosed herein, these ground truth answers may be associated with each question and answer pair, representing an actual answer to the question to be used in training the model with the question-answer pairs.

At block 1206, the model trainer circuitry 260 of FIG. 2 trains the ML model(s) with the updated dictionary from the store dataset. The updated dictionary, as described hereinabove, represents a broadened set of words related to a particular group of stores, retail location, retail industry, etc. to allow the ML model(s) to recognize a larger group of words.

At block 1208, the model trainer circuitry 260 of FIG. 2 trains the ML model(s) with classified images from the store dataset. In examples disclosed herein, the store observations may be stored in the store dataset as pre-classified images (e.g., indicating different classified items observed in the image) or may be run through the ML model for object classification (e.g., by the model trainer circuitry 260).

At block 1210, a broader set of questions are generated by the model trainer circuitry 260 of FIG. 2 using the question-answer pairs obtained from the store dataset (e.g., by the model trainer circuitry 260). That is, in examples disclosed herein, the example model trainer circuitry 260 trains the ML model(s) 293 using the question-answer pairs generated by the question-answer pair generator circuitry 250 to ensure any combination of words adequately resembling a question included in the question-answer pairs generated by the question-answer pair generator circuitry 250 (e.g., as measured by a loss score associated with training of the ML model(s) 293) is recognized as a natural language representation of that particular question. For example, a question such as “how many shelves are there?” that is part of a question-answer pair generated by the question-answer pair generator circuitry 250 may have the same answer as and/or closely resemble “what are the number of shelves?”, “what number of shelves are there?”, etc. The model trainer circuitry 260, in examples disclosed herein, broadens the recognizability of each question-answer pair to account for variations in natural language, dialects, regions, etc.

At block 1212, the model trainer circuitry 260 of FIG. 2 calculates an accuracy loss associated with training of the ML model(s). As described hereinabove, the accuracy loss may be calculated by dividing the number of accurately-determined answers (e.g., as determined by comparison against the ground truth answers obtained from the store dataset by the model trainer circuitry 260 at block 1204) by the number of overall samples.

At block 1214, the model trainer circuitry 260 of FIG. 2 determines whether the accuracy loss calculated by the model trainer circuitry 260 at block 1212 satisfies a threshold value. In examples disclosed herein, this threshold value may be a pre-determined value indicating a maximum acceptable threshold for loss. Upon determination by the model trainer circuitry 260 at block 1214 that the calculated accuracy loss satisfies the threshold value, the process ends, however, upon determination by the model trainer circuitry 260 at block 1214 that the calculated accuracy loss does not satisfy the threshold value, the process moves to block 1216.

At block 1216, the model trainer circuitry 260 of FIG. 2, upon determination at block 1214 that the calculated accuracy loss does not satisfy a threshold value, re-trains the ML model(s).

FIG. 13 is a flowchart representative of example machine readable instructions and/or example operations 1015 that may be executed and/or instantiated by processor circuitry in conjunction with the product accelerator compiler 104 of FIGS. 1 and/or 2 to provide query responses using the trained machine-learning (ML) model(s).

At block 1302, the query analyzer circuitry 270 of FIG. 2 obtains a store observation input image (e.g., from a field auditor). In examples disclosed herein, this store observation input image may be an image taken on a field auditor's personal computing device and sent via a network to the interface circuitry 210.

At block 1304, the query analyzer circuitry 270 of FIG. 2 obtains a store observation input question associated with the store observation input image obtained by the interface circuitry 210 at block 1302. In examples disclosed herein, the store observation input question obtained by the interface circuitry 210 is a natural language question related to the store observation input image.

At block 1306, the model execution circuitry 280 inputs the store observation input image and the store observation input question to the trained M/AI model(s) for determination of an answer to the field auditor's query.

At block 1308, the model execution circuitry 280 obtains an answer to the question as output of the ML/AI model(s).

At block 1310, the query response generator circuitry 290 reports the answer to the question obtained by the model execution circuitry 280 at block 1308. In examples disclosed herein, this answer may be reported by the query response generator circuitry 290 back to the field auditor (e.g., via the interface circuitry 210) and/or may be included as part of a larger report, etc.

FIG. 14 is a block diagram of an example processor platform 1400 structured to execute and/or instantiate the machine readable instructions and/or the operations of FIGS. 10-13 to implement the accelerator compiler 104 of FIGS. 1 and/or 2. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs, microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements the example interface circuitry 210, the example store dictionary generator circuitry 220, the example question processor circuitry 230, the example store image processor circuitry 240, the example question-answer pair generator circuitry 250, the example model trainer circuitry 260, the example query analyzer circuitry 270, the example model execution circuitry 280, and/or the example query response generator circuitry 290.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1432, which may be implemented by the machine readable instructions of FIGS. 10-13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may be a general purpose microprocessor (e.g., general purpose microprocessor circuitry). The microprocessor 1500 executes some or all of the machine readable instructions of the flowcharts of FIGS. 10-13 to effectively instantiate the accelerator compiler 104 of FIGS. 1 and/or 2 as logic circuits to perform the operations corresponding to those machine readable instructions. In some such examples, the accelerator compiler of FIGS. 1 and/or 2 is instantiated by the hardware circuits of the microprocessor 1500 in combination with the instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 10-13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may be implemented by at least one of an I2C bus, a SPI bus, a PCI bus, or a PCIe bus

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 16 is a block diagram of another example implementation of the processor circuitry 1412 of FIG. 14. In this example, the processor circuitry 1412 is implemented by FPGA circuitry 1600. For example, the FPGA circuitry 1300 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 10-13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowcharts of FIGS. 10-13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowcharts of FIGS. 10-13. As such, the FPGA circuitry 1600 may be structured to effectively instantiate some or all of the machine readable instructions of the flowcharts of FIGS. 10-13 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 10-13 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may be implemented by external hardware circuitry. For example, the external hardware 1606 may be implemented by the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations that may correspond to at least some of the machine readable instructions of FIGS. 10-13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modem FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowcharts of FIGS. 10-13 may be executed by one or more of the cores 1502 of FIG. 15, a second portion of the machine readable instructions represented by the flowcharts of FIGS. 10-13 may be executed by the FPGA circuitry 1600 of FIG. 16, and/or a third portion of the machine readable instructions represented by the flowcharts of FIGS. 10-13 may be executed by an ASIC. It should be understood that some or all of the accelerator compiler 104 of FIGS. 1 and/or 2 may, thus, be instantiated at the same or different times. Some or all of the circuitry may be instantiated, for example, in one or more threads executing concurrently and/or in series. Moreover, in some examples, some or all of the accelerator compiler 104 of FIGS. 1 and/or 2 may be implemented within one or more virtual machines and/or containers executing on the microprocessor.

In some examples, the processor circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

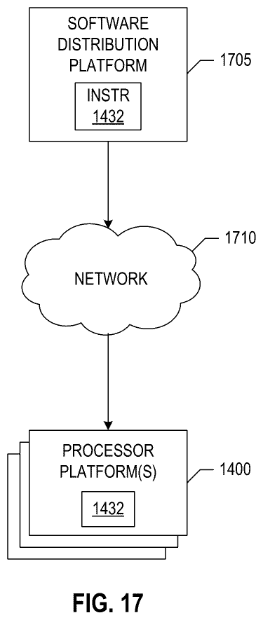

A block diagram illustrating an example software distribution platform 1705 to distribute software such as the example machine readable instructions 1432 of FIG. 14 to hardware devices owned and/or operated by third parties is illustrated in FIG. 17 The example software distribution platform 1705 may be implemented by any computer server, data facility, cloud service, etc., capable of storing and transmitting software to other computing devices. The third parties may be customers of the entity owning and/or operating the software distribution platform 17405. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions 1000, 1100, 1200, 1300 of FIGS. 10-13, as described above. The one or more servers of the example software distribution platform 1705 are in communication with an example network 1710, which may correspond to any one or more of the Internet and/or any of the example networks 1426, 1710 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions 1000, 1100, 1200, 1300 of FIGS. 10-13, may be downloaded to the example processor platform 1400, which is to execute the machine readable instructions 1432 to implement the example accelerator compiler 104 of FIGS. 1 and/or 2. In some examples, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

Example methods, apparatus, systems, and articles of manufacture for providing responses to queries regarding store observation images are disclosed. Further examples and combinations thereof include the following:

Example methods, apparatus, systems, and articles of manufacture to provide responses to queries corresponding to store observation images are disclosed herein. Further examples and combinations thereof include the following:

Example 1 includes a non-transitory computer readable medium comprising instructions that, when executed, cause a machine to at least obtain first metadata associated with a set of store dictionaries, select ones of the set of store dictionaries for use based on the associated first metadata, obtain second metadata associated with a set of question templates, select ones of the set of question templates for use based on the associated second metadata, generate question-answer pairs using the selected ones of the set of store dictionaries and the selected ones of the set of question templates, train a machine-learning model using the question-answer pairs, and generate query responses using the trained machine-learning model.

Example 2 includes the non-transitory computer readable medium as defined in example 1, further including a set of categorized store observation images.

Example 3 includes the non-transitory computer readable medium as defined in example 2, wherein the categorized store observation images are categorized based on an image type.

Example 4 includes the non-transitory computer readable medium as defined in example 3, wherein the image type is one or more of a whole image or a cropped image.

Example 5 includes the non-transitory computer readable medium as defined in example 2, wherein the instructions, when executed, cause the machine to mark the selected ones of the set of question templates for association with ones of the categorized store observation images.

Example 6 includes the non-transitory computer readable medium as defined in example 2, wherein the instructions, when executed, cause the machine to generate the question-answer pairs by determining natural language variations of the selected ones of the set of question templates.

Example 7 includes the non-transitory computer readable medium as defined in example 6, wherein the determination of the natural language variations of the set of question templates included in the store observation dataset is performed by the machine-learning model.

Example 8 includes the non-transitory computer readable medium as defined in example 1, wherein the machine-learning model is trained using an updated dictionary obtained from a store observation dataset.

Example 9 includes an apparatus to generate query responses comprising at least one memory, machine readable instructions, and processor circuitry to at least one of instantiate or execute the machine readable instructions to obtain first metadata associated with a set of store dictionaries, select ones of the set of store dictionaries for use based on the associated first metadata, obtain second metadata associated with a set of question templates, select ones of the set of question templates for use based on the associated second metadata, generate question-answer pairs using the selected ones of the set of store dictionaries and the selected ones of the set of question templates, train a machine-learning model using the question-answer pairs, and generate query responses using the trained machine-learning model.

Example 10 includes the apparatus as defined in example 9, wherein the processor circuitry is to retrieve a set of store observation images.

Example 11 includes the apparatus as defined in example 10, wherein the processor circuitry is to arrange the store observation images based on an image type.

Example 12 includes the apparatus as defined in example 11, wherein the processor circuitry is to detect the image type as at least one of a whole image or a cropped image.

Example 13 includes the apparatus as defined in example 12, wherein the processor circuitry is to identify the whole image as two or more retail shelves, and identify the cropped image as a single retail shelf.

Example 14 includes the apparatus as defined in example 10, wherein the processor circuitry is to mark selected ones of the set of question templates for association with ones of the store observation images.

Example 15 includes the apparatus as defined in example 10, wherein the processor circuitry is to generate the question-answer pairs by determining natural language variations of the selected ones of the set of question templates.

Example 16 includes a method to generate query responses comprising obtaining, by executing an instruction with processor circuitry, first metadata associated with a set of store dictionaries, selecting, by executing an instruction with the processor circuitry, ones of the set of store dictionaries for use based on the associated first metadata, obtaining, by executing an instruction with the processor circuitry, second metadata associated with a set of question templates, selecting, by executing an instruction with the processor circuitry, ones of the set of question templates for use based on the associated second metadata, generating, by executing an instruction with the processor circuitry, question-answer pairs using the selected ones of the set of store dictionaries and the selected ones of the set of question templates, training, by executing an instruction with the processor circuitry, a machine-learning model using the question-answer pairs, and generating, by executing an instruction with the processor circuitry, query responses using the trained machine-learning model.

Example 17 includes the method as defined in example 16, further including retrieving a set of store observation images.

Example 18 includes the method as defined in example 17, further including sorting the store observation images based on an image type.

Example 19 includes the method as defined in example 18, further including determining whether the image type corresponds to a whole image or a partial image.

Example 20 includes the method as defined in example 19, further including determining the whole image corresponds to two or more shelves of a store shelf structure and determining the partial image corresponds to a single shelf of a store shelf structure.

Example 21 includes the method as defined in example 17, further including marking selected ones of the set of question templates for association with ones of the store observation images.

From the foregoing, it will be appreciated that example methods, apparatus and articles of manufacture have been disclosed that extend the applications of Visual Question Answering (VQA) in retail applications and/or industries. Example methods and apparatus disclosed herein efficiently provide accurate answers to questions regarding store observations by utilizing a broadened of a dictionary and/or dataset involved in training of ML/AI model(s), as well as through generation of question-answer pairs in order to promote wider generalizability. Such a method reduces the amount of misinformation spread through inaccurate answers provided using human discretion and/or ML/AI models trained using a limited dataset and additionally reduces computational expense and/or resources. That is, in the example methods disclosed herein, an accurate and/or widely generalizable dataset is synthetically generated (e.g., through dictionary updating, generation of question-answer pairs, etc.), using machine-learning (ML) and/or artificial intelligence (AI) techniques, in order to train a more adaptable ML/AI model or a set of ML/AI models. Disclosed systems, methods, apparatus, and articles of manufacture are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A non-transitory computer readable medium comprising instructions that, when executed, cause a machine to at least:
obtain first metadata associated with a set of store dictionaries;
select ones of the set of store dictionaries for use based on the associated first metadata;
obtain second metadata associated with a set of question templates;
select ones of the set of question templates for use based on the associated second metadata; generate question-answer pairs using the selected ones of the set of store dictionaries and the selected ones of the set of question templates;
train a machine-learning model using the question-answer pairs; and
generate query responses using the trained machine-learning model.

2. The non-transitory computer readable medium as defined in claim 1, further including a set of categorized store observation images.

3. The non-transitory computer readable medium as defined in claim 2, wherein the categorized store observation images are categorized based on an image type.

4. The non-transitory computer readable medium as defined in claim 3, wherein the image type is one or more of a whole image or a cropped image.

5. The non-transitory computer readable medium as defined in claim 2, wherein the instructions, when executed, cause the machine to mark the selected ones of the set of question templates for association with ones of the categorized store observation images.

6. The non-transitory computer readable medium as defined in claim 2, wherein the instructions, when executed, cause the machine to generate the question-answer pairs by determining natural language variations of the selected ones of the set of question templates.

7. The non-transitory computer readable medium as defined in claim 6, wherein the determination of the natural language variations of the set of question templates included in the store observation dataset is performed by the machine-learning model.

8. The non-transitory computer readable medium as defined in claim 1, wherein the machine-learning model is trained using an updated dictionary obtained from a store observation dataset.

9. An apparatus to generate query responses comprising:
at least one memory;
machine readable instructions; and
processor circuitry to at least one of instantiate or execute the machine readable instructions to:
obtain first metadata associated with a set of store dictionaries;
select ones of the set of store dictionaries for use based on the associated first metadata;
obtain second metadata associated with a set of question templates;
select ones of the set of question templates for use based on the associated second metadata;
generate question-answer pairs using the selected ones of the set of store dictionaries and the selected ones of the set of question templates;
train a machine-learning model using the question-answer pairs; and
generate query responses using the trained machine-learning model.

10. The apparatus as defined in claim 9, wherein the processor circuitry is to retrieve a set of store observation images.

11. The apparatus as defined in claim 10, wherein the processor circuitry is to arrange the store observation images based on an image type.

12. The apparatus as defined in claim 11, wherein the processor circuitry is to detect the image type as at least one of a whole image or a cropped image.

13. The apparatus as defined in claim 12, wherein the processor circuitry is to:
identify the whole image as two or more retail shelves; and
identify the cropped image as a single retail shelf.

14. The apparatus as defined in claim 10, wherein the processor circuitry is to mark selected ones of the set of question templates for association with ones of the store observation images.

15. The apparatus as defined in claim 10, wherein the processor circuitry is to generate the question-answer pairs by determining natural language variations of the selected ones of the set of question templates.

16. A method to generate query responses comprising:
obtaining, by executing an instruction with processor circuitry, first metadata associated with a set of store dictionaries;
selecting, by executing an instruction with the processor circuitry, ones of the set of store dictionaries for use based on the associated first metadata;
obtaining, by executing an instruction with the processor circuitry, second metadata associated with a set of question templates;
selecting, by executing an instruction with the processor circuitry, ones of the set of question templates for use based on the associated second metadata;
generating, by executing an instruction with the processor circuitry, question-answer pairs using the selected ones of the set of store dictionaries and the selected ones of the set of question templates;
training, by executing an instruction with the processor circuitry, a machine-learning model using the question-answer pairs; and
generating, by executing an instruction with the processor circuitry, query responses using the trained machine-learning model.

17. The method as defined in claim 16, further including retrieving a set of store observation images.

18. The method as defined in claim 17, further including sorting the store observation images based on an image type.

19. The method as defined in claim 18, further including determining whether the image type corresponds to a whole image or a partial image.

20. The method as defined in claim 19, further including determining the whole image corresponds to two or more shelves of a store shelf structure and determining the partial image corresponds to a single shelf of a store shelf structure.

21. The method as defined in claim 17, further including marking selected ones of the set of question templates for association with ones of the store observation images.
